(19) United States
(12) Patent Application Publication
(10) Pub. No.: US 2015/0302523 A1
(43) Pub. Date: Oct. 22, 2015

(54) SYSTEM, METHOD AND COMPUTER READABLE MEDIUM FOR ACTIVELY MANAGED EXCHANGE TRADED FUNDS

(71) Applicant: Jeffrey C. SHAUL, Toronto, Ontario (CA)

(72) Inventor: Jeffrey C. SHAUL, Toronto, Ontario (CA)

(21) Appl. No.: 14/646,616

(22) PCT Filed: Nov. 25, 2013
(86) PCT No.: PCT/CA2013/000983

§ 371 Date: May 21, 2015

Related U.S. Application Data
(60) Provisional application No. 61/729,442, filed on Nov. 23, 2012.
(60) Provisional application No. 61/751,327, filed on Jan. 11, 2013.

(51) Int. Cl. G06Q 40/04

(52) U.S. Cl. CPC G06Q 40/04

(57) ABSTRACT

A system, method and computer readable medium buy and sell, on a secondary market, shares of a fund actively managed by a sponsor and including securities traded on exchanges. After receiving a buy order, a first price is collected from the secondary market, and a basket of the securities, equivalent to the shares, is bought on the exchanges. Then, the basket is traded for the shares from the sponsor, and the shares fulfill the buy order on the secondary market. After receiving a sell order, the shares are collected from the secondary market, and the basket is short sold on the exchanges. Then, the shares are traded for the basket from the sponsor, the basket is provided to fulfill the short sale on the exchanges, and a second price is provided to fulfill the sell order on the secondary market.

### FIELD OF THE INVENTION

The present disclosure relates generally to actively managed exchange traded funds (“ETF”) and, in particular, to systems, methods and computer readable medium for handling actively managed ETFs.

### BACKGROUND OF THE INVENTION

Investment funds, such as mutual funds, are typically corporations or trusts that are in the business of buying and selling securities while issuing shares or units that are bought by investors. The net asset value (“NAV”) of an investment fund's shares or units is calculated as the fund's total assets minus total liabilities divided by the number of outstanding shares or units. The NAV is typically calculated once per day, at the close of the financial markets. The shares or units issued by open-end mutual funds are redeemable (i.e., they can be tendered back to the issuer in exchange for cash in an amount equal to the NAV of the shares or units tendered).

Among those in the investment fund industry, an exchange traded fund (“ETF”) may be known as an investment fund whose units are listed for trading on a stock exchange. Unlike the conventional shares or units issued by open-end mutual funds, ETF shares have certain characteristics that more closely resemble common stocks, in that: (1) ETF shares are listed for trading on a stock exchange, (2) ETF shares may be bought and sold at any time during the exchange's trading hours at prevailing market prices, and (3) the market price of ETF shares fluctuates throughout the day based on supply and demand. Investors can buy and sell shares of an ETF on an exchange throughout the trading day, like a stock, including the ability to sell shares ‘short’ (i.e., sell shares that you do not yet own).

In the prior art, the conventional approach taken by a mutual fund (or mutual fund company) that desires to offer ETFs is to create a new investment fund for that purpose, through the filing of a prospectus and listing on an exchange. Mutual funds that do not currently provide ETFs face competitive pressures to offer ETF shares to their investors so as to retain the assets of the existing investors who prefer ETF shares to conventional mutual fund shares, and to attract the assets of new shareholders who may wish to trade ETF shares as part of their portfolio. However, there may be significant disadvantages to the conventional approach of creating a new investment fund to offer ETF shares to investors. For example, the additional overhead costs of a new investment fund and the appearance that the switch by investors to the new ETF from the conventional mutual fund represents the cannibalization of assets in the mutual fund.

Accordingly, it is believed that there is an unmet need and it would be useful to have a system, method and/or computer readable medium that would allow investment company sponsors to offer ETFs without having to create new investment funds for this purpose.

In the prior art, it may also be known that ETFs derive their value from a portfolio of securities that are owned by the ETF, and an investor that owns a share of the ETF owns a proportionate interest in the portfolio. Most existing ETFs hold a mix of securities designed to replicate the returns or otherwise match the characteristics of a particular published securities index or the like. These ETFs provide investors with exposure to the particular index through the shares owned by the ETF, with lower fees than comparable index-based mutual funds. ETF shares are particularly popular with short-term investors and traders, market timers, and speculators.

It may also be known that the NAV of an ETF is usually determined once each business day, usually at the close of the regular trading session on which the shares of the ETF trade. Unlike mutual funds, most transactions in ETF shares are conducted in the secondary market (i.e., on the exchange) and do not involve the movement of assets in or out of the fund. ETF shares are purchased or redeemed from the fund only in large blocks of a specified number, called a Prescribed Number of Units (“PNUs”) at the current NAV at the end of each trading day. PNUs may be purchased only by a registered dealer (alternately “Designated Broker” or “Authorized Participant”) that has entered into an agreement with the ETF sponsor governing the offer and settlement of PNUs. PNUs are separable upon issue into individual shares of the ETF, which are listed and traded at negotiated prices on a stock exchange. Shares of ETFs are generally not redeemable to an ETF unless combined into a PNU and settled, primarily in-kind, which does not impose trading costs or adverse tax consequences on the remaining shareholders.

As may also be known, the secondary market price of ETF shares trading on a stock exchange is determined by supply and demand and is affected by the current value of the portfolio of investments held by an ETF. Thus, shares will be available for purchase or sale on an intraday basis on a stock exchange at prices that will not have a fixed relationship to the previous day's NAV or the current end-of-day NAV. Prices of ETF shares on a stock exchange therefore may be below, at, or above the most recently calculated NAV of such shares.

In the prior art, purchases (also referred to as creations) and redemptions of PNUs are typically done between the Designated Broker and the ETF, with the ETF exchanging ETF shares for a block of the ETF's underlying holdings having a value equal to the ETF shares. In addition, because ETFs transact with Designated Brokers in kind by exchanging ETF shares for fund holdings, or vice versa, ETFs do not need to buy or sell securities in response to daily cash flows like an open-end mutual fund. Instead, the costs of buying and selling securities as the result of movements in and out of the fund are externalized to the Designated Brokers.

In the investment fund industry, purchases and redemptions of PNUs are effected by the Designated Brokers delivering to, or receiving from, the ETF a basket of securities which consists of a group of securities in the same proportion as they are reflected in the fund's portfolio. This in-kind purchase and redemption mechanism provides distinct advantages to ETF shareholders when compared to mutual fund investors. First, an in-kind creation externalizes costs for ETF shareholders when new investors are entering an ETF, since the fund is not required to purchase securities for more ETF shares to be issued. Second, an in-kind redemption provides tax efficiency for ETF shareholders, since a redemption does not require the fund to sell securities to satisfy a redemption in cash.

In the prior art, in order to provide intraday trading in ETF shares, the Designated Brokers must be able to engage in arbitrage and hedging activities to manage risk. Arbitrage is commonly described as either buying or selling the same security in two different markets or buying and selling two different securities one of which is convertible into the other. This is also known as a “riskless arbitrage” transaction in that the transaction is risk free since it generally consists of buying an asset at one price and simultaneously selling that same asset at a higher price, thereby generating a profit on the difference. Hedging, on the other hand, involves managing risk by purchasing or selling a security or instrument that will track or offset the value of another security or instrument.

In the prior art, Designated Brokers may buy or sell shares on the exchange, and/or purchase or redeem shares directly from the ETF at the current value of the ETF's holdings. In the event that the trading price of an ETF's shares on an exchange drifts away from the current value of the ETF's holdings, a Designated Broker can make a trading profit by exploiting such price differences. In addition, the Designated Brokers will hedge the sale or purchase of ETF shares to or from investors by taking an opposite position in the securities contained in the ETF's portfolio. By engaging in such arbitrage and hedging transactions throughout the trading day whenever an ETF's share price varies significantly from the value of its underlying holdings, the Designated Brokers provide liquidity whenever there is an imbalance of buy or sell orders for ETF shares that may otherwise cause the shares to trade at a premium or discount to the value of its underlying holdings. By supplying this liquidity, the Designated Brokers create tighter spreads in the marketplace and generally ensure that the exchange price tracks the value of the ETF's holdings closely, which benefits all investors. A relatively narrow spread is often desirable because such a spread tends to reduce the cost of buying or selling the ETF in the secondary market, which in turn tends to make the ETF a more attractive investment and encourages sales of its shares.

It may be known that in conventional ETF structures, the ETF's detailed portfolio composition is disclosed daily in order to allow arbitrage and hedging as noted above. However, this public disclosure poses challenges in connection with actively-managed investment strategies, in particular regarding the transparency of portfolio holdings. A fund is considered to be an actively-managed fund if it does not seek to track the return of a particular index by replicating or sampling index securities. An actively-managed fund's management could select investments consistent with the fund's investment objectives and policies without reference to the composition of an index.

In Canada, it may be known that actively-managed ETFs may not be required by law to provide daily disclosure of holdings, and that the only regulatory requirement is to provide complete disclosure of holdings semi-annually with the top 25 positions disclosed quarterly. Currently, however the actively-managed ETFs in Canada do disclose the portfolio component holdings on a daily basis to Designated Brokers and market makers by mutual agreement. In the United States, it may be known that regulations require all ETFs to disclose their portfolio holdings daily.

In the prior art, one of the most serious concerns that ETF sponsors have with packaging active investment strategies into actively-managed ETFs is that the managers behind the fund are quite reluctant to provide daily disclosure of the fund's portfolio holdings. If the ETF is actively managed, the composition of the portfolio of securities is intellectual property (e.g., a trade secret) of the fund held in a fiduciary capacity by the fund management, and typically must be held confidential and not disseminated to the public.

One concern that managers behind actively-managed ETFs may have with daily portfolio disclosure is the potential for free riding. That is, daily disclosure of holdings could lead to investors, or other fund managers, imitating the holdings and hence duplicating or mimicking the active manager's value-add. By doing so, an investor may obtain the benefit of the fund management's collective judgment, but does not have to pay fees to the active manager. Another concern may be the potential for front-running. Daily disclosure of holdings could result in traders seeing the daily portfolio changes, who then may attempt to make profits by front-running the active manager. Traders could anticipate the market impact and trade ahead of the active manager in situations where the manager is building up (or selling down) a position over several days.

This desire for secrecy, however, may be an issue from another perspective in that, if the composition of the actively-managed funds were not known to the Designated Broker, trading of such funds intraday could be extremely difficult since accurate pricing vehicles (such as arbitrage and hedging) would not be present. There may be no corresponding security or index or alternative fund or portfolio with which the Designated Broker could effectively compare a position.

What may be needed is a system, method and/or computer readable medium that allows the shares of an actively-managed ETF to be traded in a secondary market throughout the day, by providing a mechanism for Designated Brokers to effectively price and hedge these shares while the actual holdings of the actively-managed fund remain confidential. It may be advantageous to provide a system, method and/or computer readable medium to deter free riding and front running by maintaining the confidentiality of underlying portfolios while preserving the benefits of the proprietary management strategies and the ETF nature of the funds for investors.

It may also be advantageous to provide a system, method and/or computer readable medium adapted to facilitate the orderly processing of purchases and redemptions of units of actively-managed ETFs which includes using a blind trust or trusts for the benefit of Designated Brokers, with an independent third party, such as, for example, the fund custodian, acting as trustee of the blind trusts. The composition of the portfolio of securities of the fund may be intended to be known to the trustee of the blind trusts but not to the Designated Brokers. Designated Brokers may purchase and redeem shares of the ETF through the blind trusts, with cash to be provided to or from the blind trusts for this purpose.

Before now, in a conventional ETF as currently operated, it may have been necessary for Designated Brokers to know what securities must be delivered in a purchase or received in a redemption in order for the typical in-kind purchase and redemption process to function. What may be needed, however, is a system, method and/or computer readable medium adapted such that the Designated Broker's knowledge of the securities comprising the portfolio of a fund is not important for purposes of creation and redemption since underlying portfolio securities are not delivered to or received by the Designated Broker directly, but rather through the intermediation of a blind trust.

Prior attempts, if any, to solve problems associated with prior art devices, systems, methods and/or computer readable media may have been unsuccessful and/or had one or more disadvantages associated with them. Prior art devices, systems, methods and/or computer readable media may have been ill-suited to solve the stated problems and/or the shortcomings which have been associated with them.

It may be an object of one aspect of the present invention to provide a system, method and/or computer readable medium adapted to actively manage exchange traded funds.

It may be an object of one aspect of the present invention to provide a system, method and/or computer readable medium adapted to buy and sell, on a secondary market, shares of a fund actively managed by a sponsor.

It may be an object of one aspect of the present invention to provide a system, method and/or computer readable medium adapted to buy and sell, on a secondary market, shares of a fund actively managed by a sponsor and comprised of securities traded on one or more exchanges, with a complete list of the securities currently included in the fund being kept confidential from the secondary market.

It may be an object of one aspect of the present invention to provide a system, method and/or computer readable medium adapted to, before opening of the exchanges each trading day, receive updates from the sponsor on the securities then included in the fund.

It may be an object of one aspect of the present invention to provide a system, method and/or computer readable medium adapted to trade in-kind, with the sponsor after closing of the exchanges on the trading day, the shares and a basket of the securities that was equivalent to the shares before the opening.

It may be an object of one aspect of the present invention to provide a system, method and/or computer readable medium adapted to buy and sell the basket of the securities on the exchanges during the trading day.

It may be an object of one aspect of the present invention to provide a system, method and/or computer readable medium adapted to, after the secondary market subsystem receives a buy order, perform a buy workflow.

It may be an object of one aspect of the present invention to provide a system, method and/or computer readable medium adapted to, after the secondary market subsystem receives a sell order, perform a sell workflow.

It may be an object of one aspect of the present invention to provide a system, method and/or computer readable medium adapted to perform the buy workflow and the sell workflow.

It may be an object of one aspect of the present invention to provide a system, method and/or computer readable medium adapted for use by a market intermediary.

It may be an object of one aspect of the present invention to provide a system, method and/or computer readable medium adapted for use by a trustee of a blind trust.

It may be an object of one aspect of the present invention to provide a system, method and/or computer readable medium adapted to buy and sell shares on the secondary market via a designated broker or authorized participant.

It may be an object of one aspect of the present invention to provide a system, method and/or computer readable medium adapted to buy and sell shares on the secondary market via a designated broker or authorized participant and wherein the secondary market subsystem receives the buy order and the sell order via said designated broker or authorized participant.

It may be an object of one aspect of the present invention to provide a system, method and/or computer readable medium adapted to, when the first negotiated price is greater than an indicated intraday value of the basket as calculated based on the securities in the basket as then trading on the exchanges, perform an arbitrage workflow.

It may be an object of one aspect of the present invention to provide a system, method and/or computer readable medium adapted to perform the arbitrage workflow when the first negotiated price is greater than the indicated intraday value by a predetermined amount and/or percentage.

It may be an object of one aspect of the present invention to provide a system, method and/or computer readable medium adapted to, when the second negotiated price is less than an indicated intraday value of the basket as calculated based on the securities in the basket as then trading on the exchanges, perform an arbitrage workflow.

It may be an object of one aspect of the present invention to provide a system, method and/or computer readable medium adapted to perform the arbitrage workflow when the second negotiated price is less than the indicated intraday value by a predetermined amount and/or percentage.

It may be an object of one aspect of the present invention to provide a system, method and/or computer readable medium adapted to perform the arbitrage workflow automatically or when triggered by a user.

It may be an object of one aspect of the present invention to provide a system, method and/or computer readable medium adapted to disclose to the secondary market at one or more times during the trading day the indicated intraday value.

It may be an object of one aspect of the present invention to provide a system, method and/or computer readable medium adapted to trade the shares and the basket only in prescribed numbers of units.

It may be an object of one aspect of the present invention to provide a system, method and/or computer readable medium adapted to buy and sell, on a secondary market, shares of a fund actively managed by a sponsor and comprised of securities traded on one or more exchanges, with a complete list of the securities currently included in the fund being kept confidential from the secondary market, comprising a secondary market subsystem, a fund subsystem, an exchange subsystem, and one or more processors encoded to instruct the exchange subsystem to forthwith conduct one or more trades in a group of financial instruments during the trading day.

It may be an object of one aspect of the present invention to provide a system, method and/or computer readable medium adapted to buy and sell securities on the exchange.

It is an object of the present invention to obviate or mitigate one or more of the aforementioned disadvantages and/or shortcomings associated with the prior art, to provide one of the aforementioned needs or advantages, and/or to achieve one or more of the aforementioned objects of the invention.

### SUMMARY OF THE INVENTION

According to the invention, there is disclosed a system for buying and/or selling, on a secondary market, shares of a fund actively managed by a sponsor and including securities traded on one or more exchanges. A complete list of the securities currently included in the fund is kept confidential from the secondary market. The system includes a secondary market subsystem adapted to receive from the secondary market: (i) a buy order for the shares to be provided to the secondary market in trade for a first negotiated price to be collected from the secondary market; and/or (ii) a sell order for a second negotiated price to be provided to the secondary market in trade for the shares to be collected from the secondary market. The system also includes a fund subsystem adapted to: preferably before opening of the exchanges each trading day, receive updates from the sponsor on the securities then included in the fund; and trade in-kind, with the sponsor preferably after closing of the exchanges on the aforesaid trading day, the shares and a basket of the securities that was equivalent to the shares preferably before the aforesaid opening. The system also includes an exchange subsystem adapted to buy and/or sell the basket of the securities on the exchanges during the trading day. The system also includes one or more processors operatively encoded to perform: a buy workflow after the secondary market subsystem receives the buy order; and/or a sell workflow after the secondary market subsystem receives the sell order. In the buy workflow, the processors instruct (A) the secondary market subsystem to collect the first negotiated price from the secondary market, (B) the exchange subsystem to forthwith buy the basket of the securities on the exchanges during the trading day, (C) the fund subsystem to, preferably after the aforesaid closing, trade the basket in-kind for the shares from the sponsor, and (D) the secondary market subsystem to provide the shares to fulfill the buy order on the secondary market. In the sell workflow, the processors instruct (A) the secondary market subsystem to collect the shares from the secondary market, (B) the exchange subsystem to forthwith short sell the basket of the securities on the exchanges during the trading day, (C) the fund subsystem to, preferably after the aforesaid closing, trade the shares in-kind for the basket from the sponsor, (D) the exchange subsystem to provide the basket of the securities to fulfill the aforesaid short sale of the basket on the exchanges, and (E) the secondary market subsystem to provide the second negotiated price to fulfill the sell order on the secondary market.

According to an aspect of one preferred embodiment of the invention, the processors may preferably, but need not necessarily, be operatively encoded to, when triggered by a user, perform the buy workflow and/or the sell workflow.

According to an aspect of one preferred embodiment of the invention, the processors may preferably, but need not necessarily, be operatively encoded to, automatically, perform the buy workflow and/or the sell workflow.

According to an aspect of one preferred embodiment of the invention, the secondary market subsystem, the fund subsystem, the exchange subsystem, and/or the processors may preferably, but need not necessarily, be adapted for use by a market intermediary.

According to an aspect of one preferred embodiment of the invention, the secondary market subsystem, the fund subsystem, the exchange subsystem, and/or the processors may preferably, but need not necessarily, be adapted for use by a trustee of a blind trust.

According to an aspect of one preferred embodiment of the invention, the shares may preferably, but need not necessarily, be bought and/or sold on the secondary market via one or more dealers, designated brokers and/or authorized participants. The secondary market subsystem may preferably, but need not necessarily, receive the buy order and/or the sell order from the secondary market via the aforesaid dealers, designated brokers and/or authorized participants.

According to an aspect of one preferred embodiment of the invention, the processors may preferably, but need not necessarily, also be operatively encoded to perform an arbitrage workflow, preferably when the first negotiated price is greater than an indicated intraday value of the basket, preferably as calculated based on the securities in the basket as then trading on the exchanges. Preferably in the arbitrage workflow, the processors may preferably, but need not necessarily, instruct (a) the secondary market subsystem to short sell the shares on the secondary market, (b) the exchange subsystem to buy the basket of the securities on the exchanges, (c) the fund subsystem to trade the basket for the shares, and/or (d) the secondary market subsystem to provide the shares to fulfill the aforesaid short sale of the shares on the secondary market.

According to an aspect of one preferred embodiment of the invention, the processors may preferably, but need not necessarily, only perform the arbitrage workflow when the first negotiated price is greater than the indicated intraday value by a predetermined amount and/or percentage.

According to an aspect of one preferred embodiment of the invention, the processors may preferably, but need not necessarily, also be operatively encoded to perform an arbitrage workflow, preferably when the second negotiated price is less than an indicated intraday value of the basket, preferably as calculated based on the securities in the basket as then trading on the exchanges. Preferably in the arbitrage workflow, the processors may preferably, but need not necessarily, instruct (a) the secondary market subsystem to buy the shares in the secondary market, (b) the exchange subsystem to short sell the basket of the securities on the exchanges, (c) the fund subsystem to trade the shares for the basket, and/or (d) the exchange subsystem to provide the basket to fulfill the aforesaid short sale of the basket of the securities on the exchanges.

According to an aspect of one preferred embodiment of the invention, the processors may preferably, but need not necessarily, only perform the arbitrage workflow when the second negotiated price is less than the indicated intraday value by a predetermined amount and/or percentage.

According to an aspect of one preferred embodiment of the invention, the processors may preferably, but need not necessarily, be operatively encoded to, when triggered by a user, perform the arbitrage workflow.

According to an aspect of one preferred embodiment of the invention, the processors may preferably, but need not necessarily, be operatively encoded to, automatically, perform the arbitrage workflow.

According to an aspect of one preferred embodiment of the invention, the indicated intraday value may preferably, but need not necessarily, be disclosed to the secondary market, preferably at one or more times during the trading day.

According to an aspect of one preferred embodiment of the invention, the fund subsystem may preferably, but need not necessarily, be further adapted to, only in prescribed numbers of units, trade the shares and/or the basket as aforesaid.

According to the invention, there is also disclosed a system for buying and/or selling, on a secondary market, shares of a fund actively managed by a sponsor and including securities traded on one or more exchanges. A complete list of the securities currently included in the fund is kept confidential from the secondary market. The system includes a secondary market subsystem which carries out buying and/or selling of the shares from and/or to the secondary market. The system also includes a fund subsystem which trades in-kind, with the sponsor preferably after closing of the exchanges each trading day, the shares and a basket of the securities equivalent to the shares. The system also includes an exchange subsystem which buys and/or sells the basket of the securities on the exchanges. The system also includes one or more processors operatively encoded to instruct the exchange subsystem to forthwith, after initiation of and/or before concluding the aforesaid buying and/or the aforesaid selling of the shares, conduct one or more trades in a group of financial instruments during the trading day. The group of the aforesaid financial instruments is predetermined so the aforesaid trades in the group of the aforesaid financial instruments collectively correlate, within a predetermined tracking error range, to the aforesaid buying and/or the aforesaid selling of the shares of the fund as based on publicly available information concerning a behavior of the fund.

According to an aspect of one preferred embodiment of the invention, the system may preferably, but need not necessarily, be adapted for use with a mutual fund preferably as the fund. The mutual fund may preferably, but need not necessarily, include multiple share classes. The multiple classes of shares may preferably, but need not necessarily, include at least a first class of conventional mutual fund shares and/or at least a second class of exchange traded fund shares. The system may preferably, but need not necessarily, be adapted for use with the second class of exchange traded fund shares, preferably as the shares which are to be bought and/or sold on the secondary market as aforesaid.

According to the invention, there is also disclosed a method of buying and/or selling, on a secondary market, shares of a fund actively managed by a sponsor and including securities traded on one or more exchanges. A complete list of the securities currently included in the fund is kept confidential from the secondary market. The method includes step (a) of receiving from the secondary market: (i) a buy order for the shares to be provided to the secondary market in trade for a first negotiated price to be collected from the secondary market; and/or (ii) a sell order for a second negotiated price to be provided to the secondary market in trade for the shares to be collected from the secondary market. The method also includes step (b) of, preferably before opening of the exchanges each trading day, receiving updates from the sponsor on the securities then included in the fund. The method also includes: a buy workflow step (c) after receiving the buy order; and/or a sell workflow step (d) after receiving the sell order. The buy workflow step (c) is that of (i) collecting the first negotiated price from the secondary market, (ii) forthwith buying, on the exchanges during the trading day, a basket of the securities that was equivalent to the shares preferably before the aforesaid opening, (iii) preferably after closing of the exchanges on the aforesaid trading day, trading the basket in-kind for the shares from the sponsor, and (iv) providing the shares to fulfill the buy order on the secondary market. The sell workflow step (d) is that of (i) collecting the shares from the secondary market, (ii) forthwith short selling the basket of the securities on the exchanges during the trading day, (iii) preferably after the aforesaid closing, trading the shares in-kind for the basket from the sponsor, (iv) providing the basket of the securities to fulfill the aforesaid short sale of the basket on the exchanges, and (v) providing the second negotiated price to fulfill the sell order on the secondary market. Persons skilled in the art will appreciate, in view of the disclosures herein, that steps (a), (b), (c) and (d) may—if and/or as appropriate and according to one or more aspects of various preferred embodiment of the invention—be executed in that order, in various other orders, and/or overlapping and/or contemporaneously with one another. For example, steps (a) and (b) may be performed in that order and/or in reversed order depending on when the updates, the buy order, and the sell order are received.

According to an aspect of one preferred embodiment of the invention, the buy workflow step and/or the sell workflow step may preferably, but need not necessarily, be performed when triggered by a user.

According to an aspect of one preferred embodiment of the invention, the buy workflow step and/or the sell workflow step may preferably, but need not necessarily, be automatically performed.

According to an aspect of one preferred embodiment of the invention, the method may preferably, but need not necessarily, be adapted for use by a market intermediary.

According to an aspect of one preferred embodiment of the invention, the method may preferably, but need not necessarily, be adapted for use by a trustee of a blind trust.

According to an aspect of one preferred embodiment of the invention, preferably in steps (c) and/or (d), the shares may preferably, but need not necessarily, be bought and/or sold on the secondary market via one or more dealers, designated brokers and/or authorized participants. Preferably in step (a), the buy order and/or the sell order may preferably, but need not necessarily, be received from the secondary market via the aforesaid dealers, designated brokers and/or authorized participants.

According to an aspect of one preferred embodiment of the invention, the method may preferably, but need not necessarily, also include an arbitrage workflow step, preferably when the first negotiated price is greater than an indicated intraday value of the basket, preferably as calculated based on the securities in the basket as then trading on the exchanges. The arbitrage workflow step may preferably, but need not necessarily, be that of (e) short selling the shares on the secondary market, (f) preferably forthwith, buying the basket of the securities on the exchanges during the trading day, (g) preferably after the aforesaid closing, trading the basket in-kind for the shares from the sponsor, and/or (h) providing the shares to fulfill the aforesaid short sale of the shares on the secondary market.

According to an aspect of one preferred embodiment of the invention, the arbitrage workflow step may preferably, but need not necessarily, only be performed when the first negotiated price is greater than the indicated intraday value by a predetermined amount and/or percentage.

According to an aspect of one preferred embodiment of the invention, the method may preferably, but need not necessarily, also include an arbitrage workflow step, preferably when the second negotiated price is less than an indicated intraday value of the basket, preferably as calculated based on the securities in the basket as then trading on the exchanges. The arbitrage workflow step may preferably, but need not necessarily, be that of (e) buying the shares in the secondary market, (f) preferably forthwith, short selling the basket of the securities on the exchanges during the trading day, (g) preferably after the aforesaid closing, trading the shares in-kind for the basket from the sponsor, and/or (h) providing the basket to fulfill the aforesaid short sale of the basket of the securities on the exchanges.

According to an aspect of one preferred embodiment of the invention, the arbitrage workflow step may preferably, but need not necessarily, only be performed when the second negotiated price is less than the indicated intraday value by a predetermined amount and/or percentage.

According to an aspect of one preferred embodiment of the invention, the arbitrage workflow step may preferably, but need not necessarily, be performed when triggered by a user.

According to an aspect of one preferred embodiment of the invention, the arbitrage workflow step may preferably, but need not necessarily, be automatically performed.

According to an aspect of one preferred embodiment of the invention, the method may preferably, but need not necessarily, also include the step of disclosing the indicated intraday value to the secondary market, preferably at one or more times during the trading day.

According to an aspect of one preferred embodiment of the invention, preferably in steps (c) and/or (d), only prescribed numbers of units of the basket and/or the shares may preferably, but need not necessarily, be traded in-kind with the sponsor as aforesaid.

According to the invention, there is also disclosed a method for buying and/or selling, on a secondary market, shares of a fund actively managed by a sponsor and including securities traded on one or more exchanges. A complete list of the securities currently included in the fund is kept confidential from the secondary market. The method includes step (a) of buying and/or selling the shares from and/or to the secondary market. The method also includes step (b) of trading in-kind, with the sponsor preferably after closing of the exchanges each trading day, the shares and a basket of the securities equivalent to the shares. The method also includes step (c) of buying and/or selling the basket of the securities on the exchanges. The method also includes step (d) of forthwith, after initiation of and/or before concluding the aforesaid buying and/or the aforesaid selling of the shares, conducting one or more trades in a group of financial instruments during the trading day. The group of the aforesaid financial instruments is predetermined so the aforesaid trades in the group of the aforesaid financial instruments collectively correlate, within a predetermined tracking error range, to the aforesaid buying and/or the aforesaid selling of the shares of the fund as based on publicly available information concerning a behavior of the fund. Persons skilled in the art will appreciate, in view of the disclosures herein, that steps (a), (b), (c) and (d) may—if and/or as appropriate and according to one or more aspects of various preferred embodiment of the invention—be executed in that order, in various other orders, and/or overlapping and/or contemporaneously with one another. For example, steps (b) and (c) may be performed in that order and/or in reversed order depending on whether there is a fund share creation and/or redemption occurring.

According to an aspect of one preferred embodiment of the invention, the method may preferably, but need not necessarily, be adapted for use with a mutual fund, preferably as the fund. The mutual fund may preferably, but need not necessarily, include multiple share classes. The multiple share classes may preferably, but need not necessarily, include at least a first class of conventional mutual fund shares and/or at least a second class of exchange traded fund shares. The method may preferably, but need not necessarily, be adapted for use with the second class of exchange traded fund shares, preferably as the shares which are to be bought and/or sold on the secondary market as aforesaid.

According to the invention, there is also disclosed a computer readable medium for use in buying and/or selling, on a secondary market, shares of a fund actively managed by a sponsor and including securities traded on one or more exchanges. A complete list of the securities currently included in the fund is kept confidential from the secondary market. The computer readable medium is encoded with executable instructions. When executed, the instructions encode one or more processors to automatically perform step (a) of, preferably before opening of the exchanges each trading day, receiving updates from the sponsor on the securities then included in the fund. When executed, the instructions also encode the processors to automatically perform: a buy workflow step (b) after receiving, from the secondary market, a buy order for the shares to be provided to the secondary market in trade for a first negotiated price to be collected from the secondary market; and/or a sell workflow step (c) after receiving, from the secondary market, a sell order for a second negotiated price to be provided to the secondary market in trade for the shares to be collected from the secondary market. The buy workflow step (b) is that of instructing (i) collection of the first negotiated price from the secondary market, (ii) forthwith buying, on the exchanges during the trading day, of a basket of the securities that was equivalent to the shares preferably before the aforesaid opening, (iii) preferably after closing of the exchanges on the aforesaid trading day, trading of the basket in-kind for the shares from the sponsor, and (iv) providing of the shares to fulfill the buy order on the secondary market. The sell workflow step (c) is that of instructing (i) collection of the shares from the secondary market, (ii) forthwith short selling of the basket of the securities on the exchanges during the trading day, (iii) preferably after the aforesaid closing, trading of the shares in-kind for the basket from the sponsor, (iv) providing of the basket of the securities to fulfill the aforesaid short sale of the basket on the exchanges, and (v) providing of the second negotiated price to fulfill the sell order on the secondary market.

According to an aspect of one preferred embodiment of the invention, the executable instructions, preferably when executed, may preferably, but need not necessarily, further encode the processors preferably to perform the buy workflow step and/or the sell workflow step when triggered by a user.

According to an aspect of one preferred embodiment of the invention, the executable instructions, preferably when executed, may preferably, but need not necessarily, further encode the processors preferably to automatically perform the buy workflow step and/or the sell workflow step.

According to an aspect of one preferred embodiment of the invention, the computer readable medium may preferably, but need not necessarily, be adapted for use by a market intermediary.

According to an aspect of one preferred embodiment of the invention, the computer readable medium may preferably, but need not necessarily, be adapted for use by a trustee of a blind trust.

According to an aspect of one preferred embodiment of the invention, the executable instructions, preferably when executed, may preferably, but need not necessarily, further encode the processors to, preferably in steps (b) and/or (c), instruct the aforesaid buying and/or selling of the shares on the secondary market via one or more dealers, designated brokers and/or authorized participants. Preferably before steps (b) and/or (c), the buy order and/or the sell order may preferably, but need not necessarily, be received from the secondary market via the aforesaid dealers, designated brokers and/or authorized participants.

According to an aspect of one preferred embodiment of the invention, the executable instructions, preferably when executed, may preferably, but need not necessarily, further encode the processors preferably to perform an arbitrage workflow step, preferably when the first negotiated price is greater than an indicated intraday value of the basket, preferably as calculated based on the securities in the basket as then trading on the exchanges. The arbitrage workflow step may preferably, but need not necessarily, be that of instructing (d) short selling of the shares on the secondary market, (e) preferably forthwith, buying of the basket of the securities on the exchanges during the trading day, (f) preferably after the aforesaid closing, trading of the basket in-kind for the shares from the sponsor, and/or (g) providing of the shares to fulfill the aforesaid short sale of the shares on the secondary market.

According to an aspect of one preferred embodiment of the invention, the executable instructions, preferably when executed, may preferably, but need not necessarily, further encode the processors preferably to only perform the arbitrage workflow step when the first negotiated price is greater than the indicated intraday value by a predetermined amount and/or percentage.

According to an aspect of one preferred embodiment of the invention, the executable instructions, preferably when executed, may preferably, but need not necessarily, further encode the processors preferably to perform an arbitrage workflow step, preferably when the second negotiated price is less than an indicated intraday value of the basket, preferably as calculated based on the securities in the basket as then trading on the exchanges. The arbitrage workflow step may preferably, but need not necessarily, be that of instructing (d) buying of the shares in the secondary market, (e) preferably forthwith, short selling of the basket of the securities on the exchanges during the trading day, (f) preferably after the aforesaid closing, trading of the shares in-kind for the basket from the sponsor, and/or (g) providing of the basket to fulfill the aforesaid short sale of the basket of the securities on the exchanges.

According to an aspect of one preferred embodiment of the invention, the executable instructions, preferably when executed, may preferably, but need not necessarily, further encode the processors preferably to only perform the arbitrage workflow step when the second negotiated price is less than the indicated intraday value by a predetermined amount and/or percentage.

According to an aspect of one preferred embodiment of the invention, the executable instructions, preferably when executed, may preferably, but need not necessarily, further encode the processors preferably to perform the arbitrage workflow step when triggered by a user.

According to an aspect of one preferred embodiment of the invention, the executable instructions, preferably when executed, may preferably, but need not necessarily, further encode the processors preferably to automatically perform the arbitrage workflow step.

According to an aspect of one preferred embodiment of the invention, the executable instructions, preferably when executed, may preferably, but need not necessarily, further encode the processors preferably to instruct disclosure of the indicated intraday value to the secondary market, preferably at one or more times during the trading day.

According to an aspect of one preferred embodiment of the invention, the executable instructions, preferably when executed, may preferably, but need not necessarily, further encode the processors to, preferably in steps (b) and/or (c), instruct only prescribed numbers of units of the basket and/or the shares to be traded in-kind with the sponsor as aforesaid.

According to the invention, there is also disclosed a computer readable medium for buying and/or selling, on a secondary market, shares of a fund actively managed by a sponsor and including securities traded on one or more exchanges. A complete list of the securities currently included in the fund is kept confidential from the secondary market. The computer readable medium is encoded with executable instructions. When executed, the instructions encode one or more processors to automatically instruct performance of steps (a), (b), (c) and (d). Step (a) is that of buying and/or selling the shares from and/or to the secondary market. Step (b) is that of trading in-kind, with the sponsor preferably after closing of the exchanges each trading day, the shares and a basket of the securities equivalent to the shares. Step (c) is that of buying and/or selling the basket of the securities on the exchanges. Step (d) is that of forthwith, after initiation of and/or before concluding the aforesaid buying and/or the aforesaid selling of the shares, conducting one or more trades in a group of financial instruments during the trading day. The group of the aforesaid financial instruments is predetermined so the aforesaid trades in the group of the aforesaid financial instruments collectively correlate, within a predetermined tracking error range, to the aforesaid buying and/or the aforesaid selling of the shares of the fund as based on publicly available information concerning a behavior of the fund. Persons skilled in the art will appreciate, in view of the disclosures herein, that steps (a), (b), (c) and (d) may—if and/or as appropriate and according to one or more aspects of various preferred embodiment of the invention—be executed in that order, in various other orders, and/or overlapping and/or contemporaneously with one another. For example, steps (b) and (c) may be performed in that order and/or in reversed order depending on whether there is a fund share creation and/or redemption occurring.

According to an aspect of one preferred embodiment of the invention, the computer readable medium may preferably, but need not necessarily, be adapted for use with a mutual fund, preferably as the fund. The mutual fund may preferably, but need not necessarily, include multiple share classes. The multiple share classes may preferably, but need not necessarily, include at least a first class of conventional mutual fund shares and/or at least a second class of exchange traded fund shares. The computer readable medium may preferably, but need not necessarily, be adapted for use with the second class of exchange traded fund shares, preferably as the shares which are to be bought and/or sold on the secondary market as aforesaid.

Other advantages, features and/or characteristics of the present invention, as well as methods of operation and/or functions of the related elements of the system, method and computer readable medium, and/or the combination of steps, parts and/or economies of manufacture, will become more apparent upon consideration of the following detailed description and the appended claims with reference to the accompanying drawings, the latter of which are briefly described hereinbelow.

### BRIEF DESCRIPTION OF THE DRAWINGS

The novel features which are believed to be characteristic of the system, method, and computer readable medium according to the present invention, as to their structure, organization, use, and/or method of operation, together with further objectives and/or advantages thereof, will be better understood from the following drawings in which presently preferred embodiments of the invention will now be illustrated by way of example. It is expressly understood, however, that the drawings are for the purpose of illustration and description only, and are not intended as a definition of the limits of the invention. In the accompanying drawings:

FIG. 1 is a schematic diagram depicting a system for handling actively managed exchange traded funds according to one preferred embodiment of the invention;

FIG. 2 is a schematic diagram depicting a structure and actions of members that would generally be involved in handling actively managed exchange traded funds, using a blind trust, according to one preferred embodiment of the invention;

FIG. 3 depicts flowcharts of methods of handling creations and redemptions for actively managed exchange traded funds with hedging through blind trust according to a preferred embodiment of the invention;

FIG. 4 depicts flowcharts of methods of arbitrage for actively managed exchange traded funds by designated brokers through blind trust according to a preferred embodiment of the invention;

FIG. 5 is a schematic diagram depicting a structure and actions of members that would generally be involved in implementing an independent trustee platform for multiple designated brokers and multiple exchange traded funds according to a preferred embodiment of the invention;

FIG. 6 is a schematic diagram depicting a structure and actions of members that would generally be involved in handling actively managed exchange traded funds, using a market intermediary, according to one preferred embodiment of the invention;

FIG. 7 is a schematic diagram depicting a structure and actions of members that would generally be involved in implementing an independent third party intermediary platform for multiple dealers and multiple exchange traded funds according to a preferred embodiment of the invention;

FIG. 8 depicts flowcharts of methods of handling creations and redemptions for actively managed exchange traded funds with hedging through market intermediary according to a preferred embodiment of the invention;

FIG. 9 depicts flowcharts of methods of arbitrage for actively managed exchange traded funds by market intermediary according to a preferred embodiment of the invention;

FIG. 10 is a schematic diagram depicting creation for actively managed exchange traded funds with hedging through market intermediary according to a preferred embodiment of the invention;

FIG. 11 is a schematic diagram depicting redemption for actively managed exchange traded funds with hedging through market intermediary according to a preferred embodiment of the invention;

FIG. 12 is a schematic diagram depicting arbitrage for actively managed exchange traded funds by market intermediary when the secondary market price of ETF shares is higher than the IIV, according to a preferred embodiment of the invention; and

FIG. 13 is a schematic diagram depicting arbitrage for actively managed exchange traded funds by market intermediary when the secondary market price of ETF shares is lower than than the IIV, according to a preferred embodiment of the invention.

### DETAILED DESCRIPTION OF THE PREFERRED EMBODIMENTS

According to a preferred embodiment of the present invention, there is provided a system, method and computer readable medium adapted to allow the shares of an actively-managed ETF to be traded in a secondary market throughout a day, by providing a mechanism for designated brokers (alternately “registered dealers”) to effectively price and hedge/arbitrage these shares while the actual holdings of the actively-managed fund remain confidential. The systems, methods and computer readable media described herein are intended to deter free riding and front running by maintaining the confidentiality of underlying portfolios while preserving the benefits of the proprietary management strategies and the ETF nature of the funds for investors.

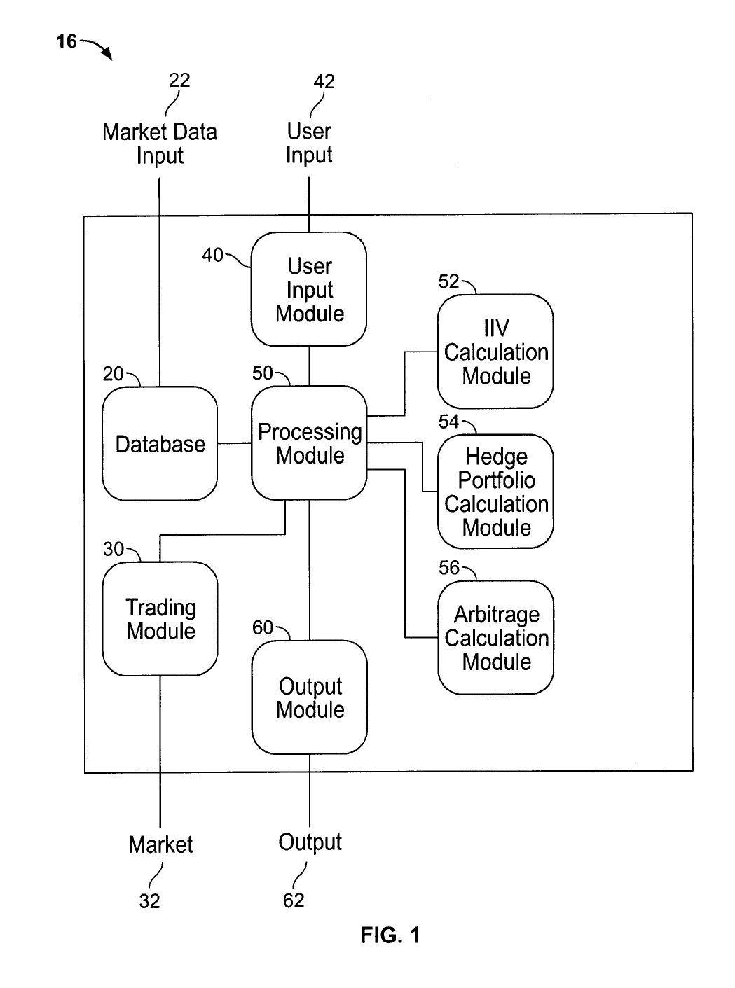

Referring to FIG. 1, an embodiment of the present invention is depicted. A system 16 may comprise: a database 20 for receiving market data input 22 (e.g., negotiated securities prices, indicative intraday values); a trading module 30 for interfacing with the market 32 (e.g., to buy and sell securities); a user input module 40 for receiving user input 42 (e.g., predetermined amount or ratio by which a negotiated price may differ from an indicative intraday value); a processing module 50 for interfacing with an indicative intraday value (“IIV”) module 52 (e.g., to calculate an IIV throughout the day), a hedge portfolio calculation module 54 (e.g., to determine the appropriate conditions for hedging), and/or an arbitrage calculation module 56 (e.g., to determine the appropriate conditions for arbitrage); and/or an output module 60 for presenting an output 62 (e.g., presenting the trades conducted, current market data, present IIV, etc.).

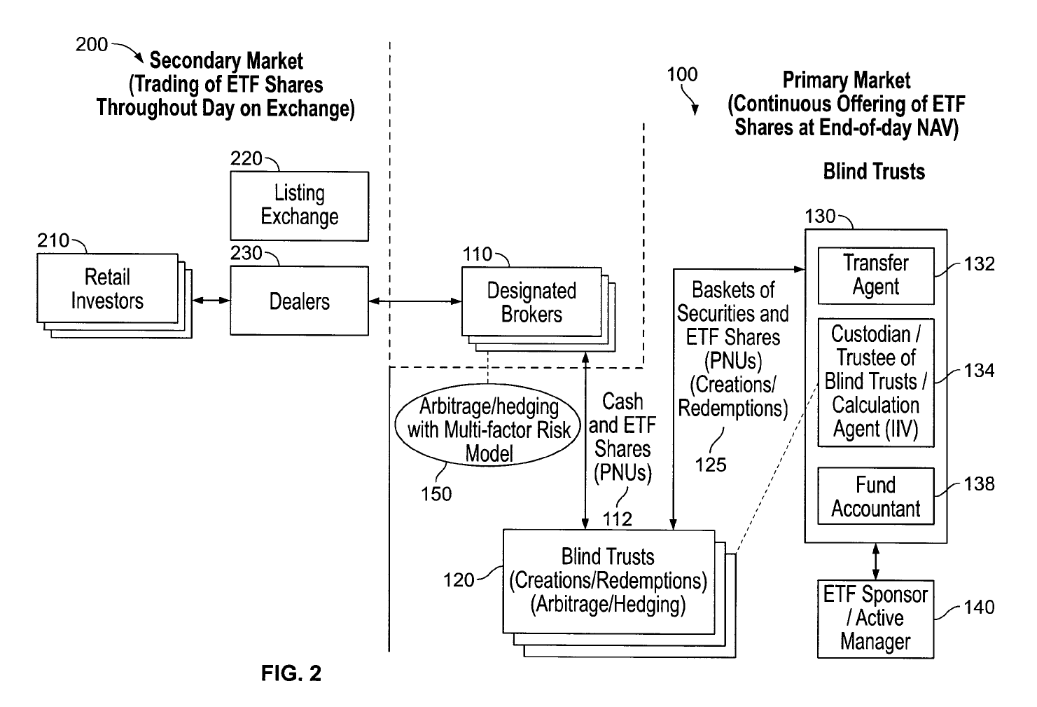

Referring to FIG. 2, a block or schematic diagram depicts creations and redemptions of ETF shares using a blind trust 120. According to an embodiment of the present invention, a secondary market 200 (which may involve the trading of ETF shares throughout the day) includes one or more retail investors (alternately “investors”) 210, a listing exchange 220 and dealers 230. Notably, a designated broker 110 may be a part of the secondary market 200, a primary market 100, or interposed between the blind trust 120 and the secondary market 200. As also shown in FIG. 2, the primary market 100 (which may be adapted for the continuous offering of ETF shares at end-of-day NAV) may also include an ETF sponsor (alternately “active manager”, “fund sponsor”) 140 in association with a third party (alternately “fund” or “mutual fund”) 130 comprising a transfer agent 132, a custodian/trustee of blind trusts/calculation agent (hereinafter alternately “custodian”, “trustee of blind trusts”, “calculation agent” or a combination of the foregoing) 134 and/or a fund accountant 138.

In a preferred embodiment, FIG. 2 depicts the orderly processing of purchases and redemptions of units of actively-managed ETFs using a blind trust 120 or trusts for the benefit of a Designated Broker 110, with an independent third party (which may, for example, be the fund custodian) acting as trustee of the blind trusts 134. The composition of the portfolio of securities of the fund is intended to be known to the trustee of the blind trusts 134 but not to the Designated Brokers 110. Designated Brokers 110 will purchase and redeem shares of the ETF by exchanging cash and ETF shares (PNUs) 112 with the blind trusts 120.

Arbitrage and hedging activities are intended to be carried out by Designated Brokers 110 in the blind trusts 120 by providing instructions to the trustee of the blind trusts 134 to purchase or sell the underlying securities of the fund 130, and/or alternatively through the application of an arbitrage/hedging with multi-factor risk model 150 to construct, for example, a hedging portfolio.

The daily NAV of the ETF on a per share basis may be calculated and disseminated publicly by the ETF sponsor 140 each business day. The fund custodian (or, hereinafter, a party acting as calculation agent and/or the trustee of the blind trusts) 134, will have knowledge of the components of the ETF portfolio, and may calculate and disseminate publicly through the listing exchange 220 on which the ETF shares are primarily listed, an IIV for the ETF on a per share basis periodically throughout the trading day, for example, every fifteen seconds or other appropriate time period. It will be understood that other periodic intervals, such as every ten, twenty, thirty, forty, fifty seconds or every “x” minutes may be specified by the ETF sponsor 140. The IIV is a real-time calculation that represents the current value of the ETF's holdings (less liabilities), intended to give retail investors 210 and any other market participants a per share value that is very close to what the intraday NAV would be, if it were calculated. At the end of the trading day, the IIV and the official NAV should be nearly identical.

The ETF sponsor 140, as shown in FIG. 2, may be responsible for monitoring the accuracy of the IIV calculation, and ensuring that the calculation agent 134 has an accurate listing of all securities in the ETF's portfolio as of the beginning of trading on each day the ETF is traded. The ETF sponsor 140 may enter into a contractual arrangement with a calculation agent 134 to provide services, provide the same portfolio information to the calculation agent 134 as is provided for calculation of its NAV and provide such information in a secure, confidential and electronic manner.

Those skilled in the art may appreciate, in view of the disclosures herein, that the IIV may be one number, usually based on the last trade, that is calculated and disseminated publicly at one or more times throughout the trading day. Persons skilled in the art may also appreciate, in view of the disclosures herein, that the IW may in addition and/or instead be calculated based on various other factors, e.g., based on a midpoint between one or more bid and ask prices.

The IIV disseminated throughout the trading day can help establish tight valuation ranges, for example with lower spreads between bid and ask (i.e., purchase price and sale price), which would lead to tighter pricing in markets for the basket of securities used to establish the actively-managed ETF shares. To the extent that trading in the basket would facilitate the creation of more units of the ETF shares, the cost of maintaining and operating the portfolio may be spread over a larger pool of assets. Consequently, the costs per-dollar of assets in the portfolio or basket may be reduced.

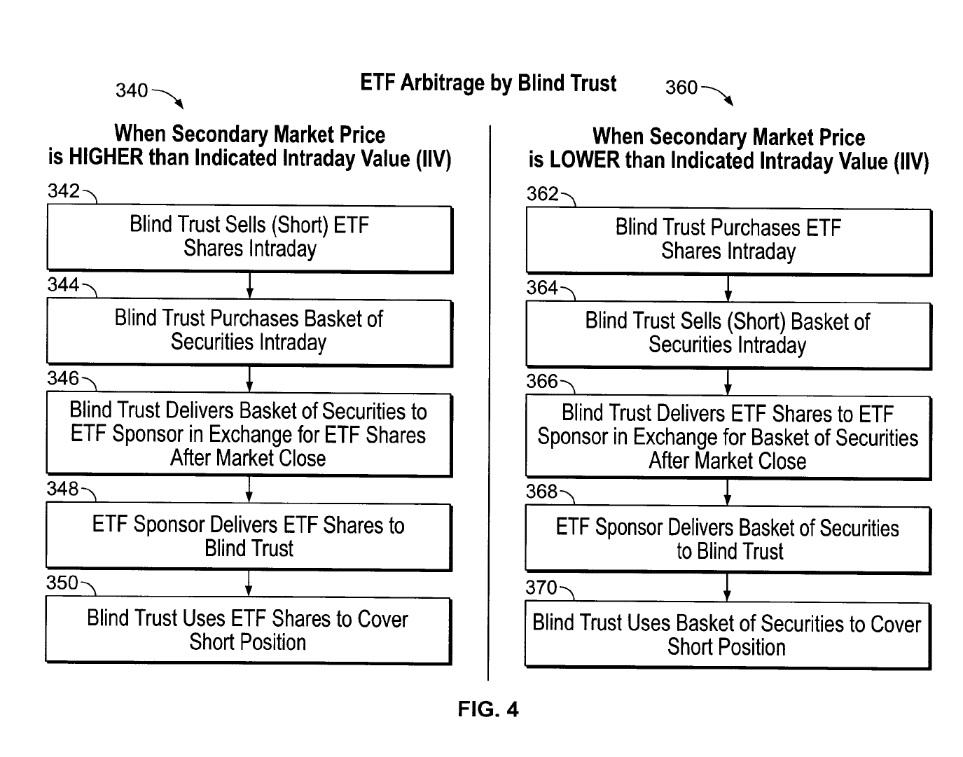

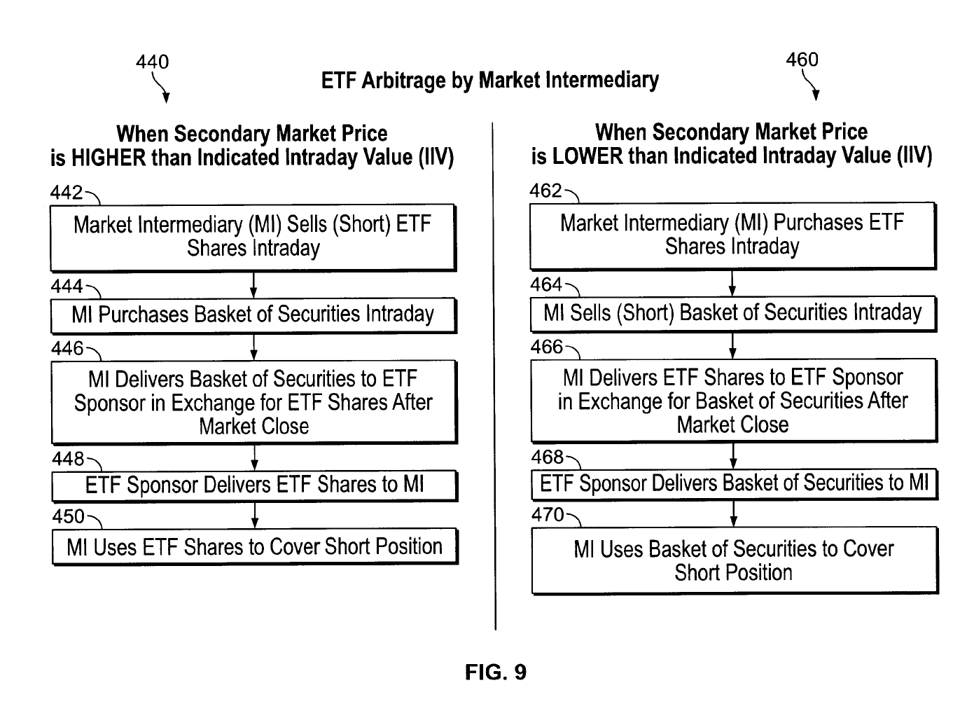

Arbitrage may refer to a spread between the IIV and the trading price of the corresponding ETF share. The arbitrage activities of a designated broker 110 or blind trust 120 (as described below, for example, in FIG. 4) or third party market intermediary 170 (as described below, for example, in FIG. 9) may be based on the spread between the prices at which the basket of securities could be bought/sold (e.g., short) (which would be provided only to the designated broker 110 or known to the market intermediary 170, and would not be part of the publicly disseminated IIV) and the prices at which the ETF shares could be sold (e.g., short) and/or bought. Notably, the foregoing prices may be refined for large volumes of trades.

The systems, methods and computer readable media herein are intended to provide a number of benefits. The costs of creating an additional share class of an existing mutual fund would be lower than those of creating a new fund. An investment fund that offers more classes may attract more assets, and will thus be able to realize further economies of scale by spreading the ongoing fixed costs over a larger asset base. Advantageously, transfer agency costs, order processing costs and/or other administrative costs may be much lower for an ETF than for a conventional mutual fund. Redemptions from the ETF share class can be fulfilled in-kind, a more tax efficient technique than redemption in cash of conventional mutual fund shares or units which require the sale of portfolio securities by the investment fund. The in-kind conversion feature may allow investors 210 to move from the conventional share class to the ETF share class without disrupting the fund's portfolio.

Under the present system, method and/or computer readable medium, the mutual fund 130 may be less likely to suffer from the disruptive effects of short-term investors. Short-term investors may raise expenses by forcing an investment company to incur brokerage expenses and other transaction costs as portfolio securities are bought and sold to meet frequent purchase and redemption requests. They may also increase the chance that the investment company might have to sell stock to raise cash to pay a redeeming shareholder, causing the fund 130 to incur capital gains and decreasing the tax efficiency of the fund. The uncertainty of frequent cash flows may make it more difficult to keep the portfolio appropriately balanced.

Investments in the ETF share class may be included in the mutual fund's 130 total assets under management, thus lessening the appearance of cannibalization that would otherwise result with the creation of a new ETF. The switch by investors 210 from the conventional mutual fund class to the ETF share class should not change the mutual fund's 130 total assets under management.

Blind Trust

Referring to FIG. 2, whenever there appears to be a relatively large spread, at any time during the trading day, between the IIV and the trading price of shares of the ETF, the Designated Broker 110 can initiate arbitrage or hedging transactions by giving instructions to the trustee of the blind trust 134 to buy (or short sell) in the blind trust 120 securities of the underlying portfolio representing a predetermined aggregate number of ETF shares or a predetermined aggregate dollar amount, in proportion to the relative weights of such securities in the portfolio. More particularly, the blind trust 120 may exchange baskets of securities and ETF shares (PNUs) (Creations/Redemptions) 125 with the third party 130. This approach is intended to allow the actual composition of the portfolio of securities of the ETF to be used for arbitrage and hedging purposes without the contents of the portfolio of securities being disclosed to the Designated Broker 110. The ETF sponsors 140 will not make their holdings and trading activity known to market participants, except in accordance with disclosure requirements otherwise applicable under laws or securities regulations (such as those applicable to open-end mutual funds).

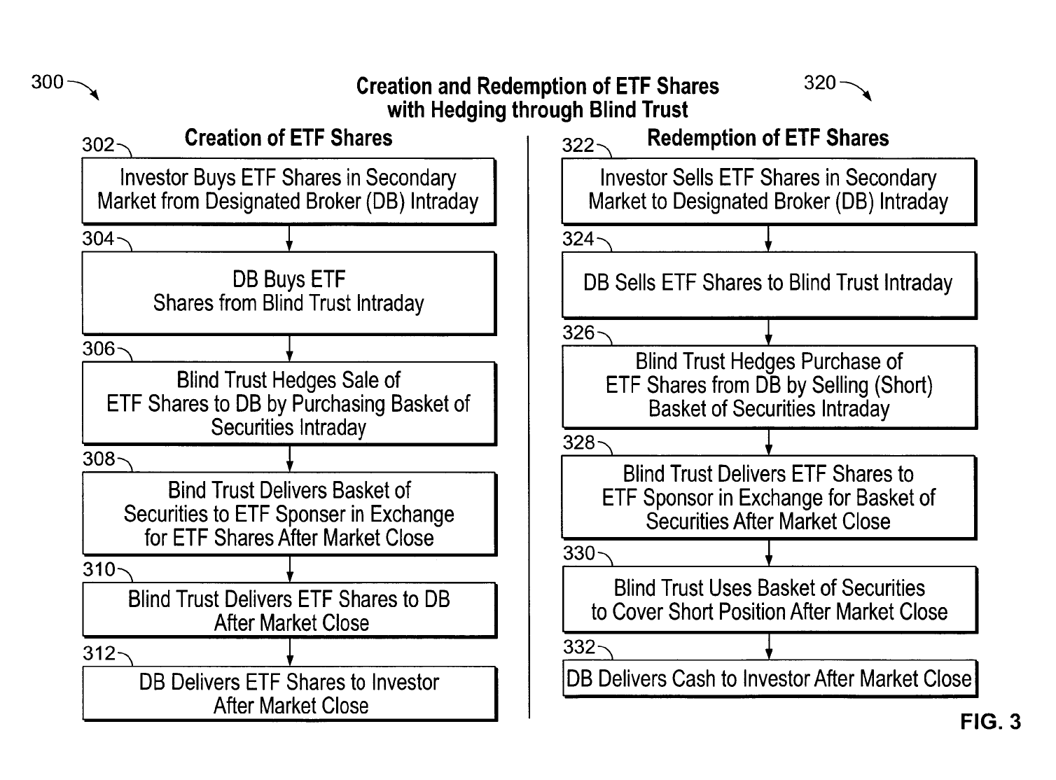

FIG. 3 depicts selected steps of a method of creation of ETF shares with hedging through blind trust 300 and a method of redemption of ETF shares with hedging through blind trust 320. The methods 300 and 320 are suitable for use with the system 16 described above and shown in FIGS. 1, 2 and 5, but it is not so limited.

As shown in FIG. 3, the method 300 includes the following steps, among others: an investor buys ETF shares in secondary market from designated broker (DB) intraday step 302; a DB buys ETF shares from blind trust intraday step 304; a blind trust hedges sale of ETF shares to DB by purchasing basket of securities intraday step 306; a blind trust delivers basket of securities to ETF sponsor in exchange for ETF shares after market close step 308; a blind trust delivers ETF shares to DB after market close step 310; and a DB delivers ETF shares to investor after market close step 312. Thus, it will be appreciated that, according to the method 300, ETF shares may be created with hedging through a blind trust.

Also as shown in FIG. 3, the method 320 includes the following steps, among others: an investor sells ETF shares in secondary market to designated broker (DB) intraday step 322; a DB sells ETF shares to blind trust intraday step 324; a blind trust hedges purchase of ETF shares from DB by selling (short) basket of securities intraday step 326; a blind trust delivers ETF shares to ETF sponsor in exchange for basket of securities after market close step 328; a blind trust uses basket of securities to cover short position after market close step 330; and a DB delivers cash to investor step after market close 332. Thus, it will be appreciated that, according to the method 320, ETF shares may be redeemed with hedging through a blind trust.

FIG. 4 depicts selected steps of a method of arbitrage by designated brokers through blind trust (i) when the secondary market price is higher than IIV 340, and/or (ii) when the secondary market price is lower than IIV 360. The methods 340, 360 are suitable for use with the system 16 described above and shown in FIGS. 1, 2 and 5, but it is not so limited.

As shown in FIG. 4, the method 340 includes the following steps, among others: a blind trust sells (short) ETF shares intraday step 342; a blind trust purchases basket of securities intraday step 344; a blind trust delivers basket of securities to ETF sponsor in echange for ETF shares after market close step 346; an ETF sponsor delivers ETF shares to blind trust step 348; and a blind trust uses ETF shares to cover short position step 350. Thus, it will be appreciated that, according to the method 340, ETF shares may be created when the secondary market price is higher than the HV.

As also shown in FIG. 4, the method 360 includes the following steps, among others: a blind trust purchases ETF shares intraday step 362; a blind trust sells (short) basket of securities intraday step 364; a blind trust delivers ETF shares to ETF sponsor in exchange for basket of securities after market close step 366; an ETF sponsor delivers basket of securities to blind trust step 368; and a blind trust uses basket of securities to cover short position step 370. Thus, it will be appreciated that, according to the method 360, ETF shares may be redeemed when the secondary market price is lower than the IIV.

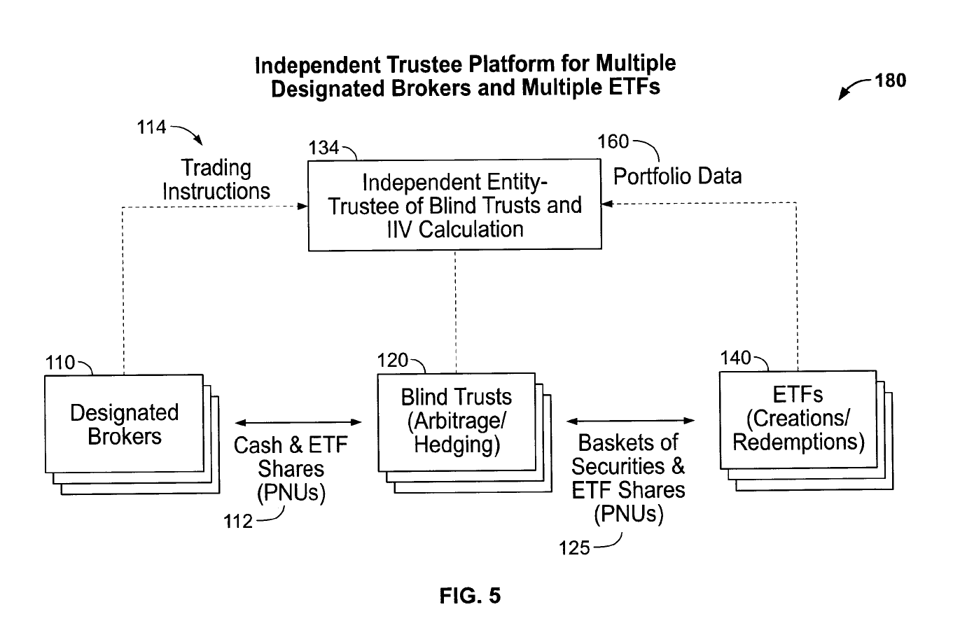

As depicted in FIG. 5, it will be understood that the systems 16, methods and computer readable media herein may be implemented whereby an independent third party acts as trustee and calculation agent 134 of the blind trusts 120 for a number of ETF sponsors 140 and a number of designated brokers 110. This implementation may facilitate efficiencies in the purchase or short sale of the portfolio securities underlying the ETFs by allowing for portfolio securities to be purchased (or sold), or alternatively borrowed (or lent) for short sales, among the blind trusts 120. In the depicted independent trustee platform for multiple designated brokers and multiple ETFs 180, the designated brokers 110 may provide trading instructions 114 to the trustee and IIV calculation agent 134. The trustee and IIV calculation agent 134 may also receive portfolio data 160 associated with the ETFs 140. The blind trusts 120 may exchange cash and ETF shares (PNUs) 112 with the designated brokers 110 in addition to baskets of securities and ETF Shares (PNUs) 125 with the ETF sponsors 140.

In a conventional ETF as currently operated (not shown), it may be necessary for Designated Brokers 110 to know what securities must be delivered in a purchase or received in a redemption in order for the typical in-kind purchase and redemption process to function. However, for an actively-managed ETF Sponsor 140 operating based on embodiments described in the present disclosure, the Designated Broker's 110 knowledge of the securities comprising the portfolio of a fund 130 may not be important for the purposes of creation and redemption since underlying portfolio securities are not delivered to or received by the Designated Broker 110 directly, but rather through the intermediation of a blind trust 120.

With respect to the purchase of ETF shares, and with reference to FIG. 2, PNUs can be purchased solely by the deposit of cash (i.e., exchange of cash and ETF shares (PNUs) 112) by the Designated Brokers 110 to the blind trusts 120 equal to NAV, for purchase by the trustee 134 of the baskets of securities and then delivery to the actively-managed ETF in exchange for PNUs (i.e., baskets of securities and ETF shares (PNUs) (creations/redemptions) 125). As shown in FIG. 3, redemptions 320 would be effected by the transfer in-kind by the ETF to the blind trusts of the baskets of securities after market close 328, that may then be liquidated by the blind trust for cash 330, which should be generally equal to NAV. All income, gain or loss realized by the blind trust 120 can then be directly attributed to the Designated Broker 110 with the same effect as if it sold those securities directly. Throughout the process, the identity and composition of the ETFs portfolio securities does not need to be disclosed.

The ability of market participants to accurately hedge their positions in ETF shares may not rest on the ability of market participants to anticipate changes in the portfolio of the fund 130, but could be based on the calculation of the current spread between the market value of the ETF's underlying holdings, as accurately represented on a real-time basis by the IIV, and the current bid/ask price of the ETF shares. The dissemination of a reliable IIV calculation, together with the ability of Designated Brokers 110 to purchase and redeem PNUs each day at NAV through the use of the blind trust 120, is intended to allow market participants to effectively engage in arbitrage and hedge trading exposures in the shares of ETFs and to permit the efficient trading of shares of ETFs in the marketplace. This approach is thus also intended to discourage significant deviations between the market price of the actively-managed ETF shares and the intraday value of the fund 130. At the same time, non-disclosure of the daily portfolio contents of the fund 130 is intended to avoid the risks of free riding and front running that may potentially impact actively-managed funds that disclose their holdings.

While the fund 130 may generally distribute securities in-kind in proportion to the composition of the portfolio, the fund sponsor 140 may determine from time to time that it is not in the fund's 130 best interests to distribute securities in-kind, but rather to sell securities and/or distribute cash. For example, the fund sponsor 140 may distribute cash to facilitate orderly portfolio management in connection with rebalancing or transitioning a portfolio in line with its investment objective, if there is substantially more creation than redemption activity during the period immediately preceding a redemption request, or as necessary or appropriate in accordance with applicable laws and regulations. Alternatively, the ETF sponsor 140 may choose to select redemption securities that do not represent an exact slice of an ETF's portfolio in order to effectively implement changes to the ETF's portfolio composition, to take advantage of tax strategies or to address corporate actions. However, for consistency, each Designated Broker 110 redeeming on a given day could be provided with the same set of redemption securities on such day.

Increasing the number of actively-managed ETFs available in the market would be expected to afford significant benefits to investors 210, for example, the availability of actively-managed ETF shares would be expected to: provide increased investment opportunities which should encourage diversified investment; provide, in the case of individual shares, a low-cost diversified security for small- and middle-sized accounts of individuals and institutions that would be available at intraday prices reflecting market conditions rather than only their once-daily NAV price; provide a security that should be freely available in response to market demand; provide competition for comparable products available in the market; provide enhanced liquidity; facilitate the implementation of diversified investment management techniques; and provide a tax efficient investment vehicle.

The previously discussed aspect of the present disclosure (as shown, for example, in FIG. 2), a system of facilitating the orderly processing of purchases and redemptions of units of actively-managed ETFs using a blind trust 120 or trusts for the benefit of Designated Brokers 110, with the fund custodian 134 or another independent third party acting as trustee of the blind trusts 134 is intended to make the system and method of a separate ETF class easier to implement. It may be expected to be more efficient for the mutual fund 130 to effect the creations and redemptions of the ETF class shares by dealing with one trustee of many blind trusts as opposed to dealing directly with a plurality of Designated Brokers 110.

According to an aspect herein (and as may be seen in FIG. 2), there is provided a method of facilitating the purchase/creation and redemption of units of an actively-managed ETF comprising creating a blind trust for the benefit of market makers (which may include, among others, designated brokers 110), with the fund custodian or other independent third party acting as trustee of the blind trust 134, and allowing hedging and arbitrage activities through the blind trust 120 by periodically, at a predetermined interval, publishing a value (called the intraday indicative value (“IIV”)) of the underlying holdings of the ETF. The composition of the portfolio of securities of the fund 130 will be known to the trustee of the blind trust 134, and hence the blind trust 120, but not to the market makers. Market makers will be provided with the IIV for the units of the fund 130 and may purchase and redeem shares of the ETF through the blind trust 120.

As noted above (and shown, for example, in FIG. 5), systems 16, methods and/or computer readable media may be implemented whereby one independent third party 134 acts as trustee of the blind trusts and calculation agent for a number of actively managed ETFs 140 and a number of designated brokers 110. Arbitrage and hedging activities may be carried out by market makers either in the blind trusts 120, by providing trading instructions 114 to the trustee of the blind trusts 134 to purchase or sell the underlying securities of the fund 130 on their behalf, or alternatively through the application of a multi-factor risk model (not shown) to construct a hedging portfolio.

Arbitrage and Hedging by Designated Brokers

With reference to FIG. 2, in the event that the trading price of an ETF's shares on an exchange drifts away from the current value of the ETF's holdings, a Designated Broker 110 may make a trading profit by exploiting such price differences. By engaging in such arbitrage and market making transactions throughout the trading day whenever an ETF's share price varies significantly from the value of its underlying holdings or, in embodiments described herein, of its IIV, the Designated Brokers 110 may provide liquidity whenever there is an imbalance of buy or sell orders for ETF shares that may otherwise cause the shares to trade at a premium or discount to their underlying value. By supplying this liquidity, the Designated Brokers 110 attempt to create tighter spreads in the marketplace and generally ensure that the exchange price generally tracks the value of the ETF holdings closely, which benefits all investors 210. The ability of Designated Brokers 110 to create and redeem ETF shares helps the ETF shares trade at a price that approximates its underlying value.

Such arbitrage activities can be described as follows. When an ETF is trading at a discount to its underlying value, as calculated by a Designated Broker 110 with knowledge of the underlying portfolio, the Designated Broker 110 may buy the ETF shares during the day and at the same time sell short the underlying securities. At the end of the day, the Designated Broker 110 could redeem the ETF shares in exchange for the ETF's basket of securities that the Designated Broker 110 will use to cover its short positions. The Designated Broker 110 will earn a profit equal to the spread between the lower price paid for the ETF shares and the higher price it received for the underlying securities. This profit does not change, regardless of whether the end of day NAV has changed from the previous calculation. If the end of day NAV has changed, the profitability of the purchase of the ETF shares and short sale of the underlying securities will be equally and oppositely affected. The order to buy the ETF shares would tend to drive up the price of the ETF shares, thereby decreasing the spread, and helping the ETF shares to trade at a market price more closely approximating its underlying value.

Conversely, when an ETF is trading at a premium to its underlying value, as calculated by a Designated Broker 110 with knowledge of the underlying portfolio, the Designated Broker 110 may sell short the ETF during the day and at the same time buy the underlying securities. At the end of the day, the Designated Broker 110 could deliver the basket of securities to the ETF in exchange for ETF shares that the Designated Broker 110 will use to cover its short position. The Designated Broker 110 will earn a profit equal to the spread between the lower price paid for the underlying securities and the higher price received for the ETF shares. Again, this profit does not change, regardless of whether the end of day NAV has changed from the previous calculation. If the end of day NAV has changed, the profitability of the purchase of the underlying securities and the short sale of the ETF shares will be equally and oppositely affected. The order to sell short the ETF shares would tend to reduce the price of the ETF shares, thereby decreasing the spread, and helping the ETF shares to trade at a market price more closely approximating its underlying value.

The arbitrage activities described above may be carried out in an equally effective manner using the IIV and blind trust 120. Since the IIV will be very close to what the intraday NAV would be if it were calculated, and should be nearly identical to the official NAV at the end of the trading day, the IIV could act as the proxy for the value of the underlying securities as currently calculated by the Designated Brokers 110. Also, short sales of the underlying securities when the ETF shares are trading at a discount to the IIV, or conversely purchases of the underlying securities when the ETF shares are trading at a premium to the IIV, could be effected in the blind trusts 120 by the Designated Broker 110 providing instructions to the trustee to execute such short sale or purchase transactions, in proportion to the weights of the underlying securities in the portfolio, representing a predetermined aggregate number of ETF shares or a predetermined aggregate dollar amount. Since the Designated Broker 110 would be the sole beneficiary of the blind trust, it would earn the same profit described above.

The near-perfect correlation between the value of the basket of securities and the NAV of the ETF or, in embodiments described herein, its IIV, helps make the aforementioned spread-narrowing maneuvers profitable for the Designated Broker 110. Furthermore, a relatively narrow spread tends to reduce the cost of buying or selling the ETF in the secondary market 200, which in turn tends to make the ETF a more attractive investment and encourages sales of its shares.

As also shown in FIG. 2, according to another aspect of the system 16, method and/or computer readable medium herein, arbitrage/hedging with multi-factor models 150 may be used to develop a hedging portfolio that can be used for arbitrage and hedging activities in actively-managed ETFs, based only on public information rather than the actual ETF fund 130 holdings. In this aspect, a method of using multifactor models includes extracting factor information based on the investment objectives and strategies of the actively-managed ETF 140 and determining external factors that may affect the price of its shares. Additionally, the method may also include selecting a portfolio of financial instruments with similar behaviour with respect to the determined factors and using multi-factor risk models to produce a hedging portfolio that tracks the price of the actively-managed ETF, without knowledge of the composition of the portfolio of the fund 130.

Designated Brokers 110 and other market participants may be able to determine how to trade actively-managed ETF shares at levels approximating the IIV without taking undue risk through the selection of various market factors, for example, general market movements, sensitivity of the IIV to intraday movements in interest rates or commodity prices, and other benchmarks. Designated Brokers 110 and other market participants may then be able to examine how these factors affect IIV. Designated Brokers 110 may identify financial instruments correlated with these factors and the IIV to a desired level of accuracy, and then develop a portfolio that can be used for arbitrage and hedging purposes. The financial instruments can be any type that has a definite value that may be tracked over time, and may be securities or portfolios of securities, ETFs, hedge funds, derivatives, commodities futures, listed commodity pools, listed commodity funds, and/or other investment vehicles.

Some or all of the selected financial instruments may be selected based upon a similarity to the actively-managed ETF's investment objectives and strategies. For example, if it is publicly known that a substantial portion of the actively-managed ETF's 140 portfolio of securities includes securities from a particular industry sector, then the financial instruments may be selected from that industry sector. Other similarities between the financial instruments and the actively-managed ETF 140 may be arranged, so long as those similarities are determined using only public information about the fund 130.

As an example, the hedge portfolio may be a weighted group of financial instruments, in selected proportions determined by their weights, which may take any real value, including negative values, which would represent a short position in the financial instrument. In principle, any number of financial instruments can provide a desired correlation. While the hedge portfolio might consist of five to twenty financial instruments, in general, using relatively few is desirable because of the fewer transactions and lower transaction costs associated with assembling the hedge portfolio.

The weights of the financial instruments in the hedge portfolio may be determined by performing a multiple regression analysis on the historical returns of the fund 130 and the returns of the financial instruments. The amount of historical data needed may generally depend upon the number of selected financial instruments, and how close of a correlation may be desired between the hedge portfolio and the ETF. The hedge portfolio may be further selected so that it has a small tracking error relative to the fund 130, lower than a pre-determined threshold. Choosing the weights so that the tracking error is small may be accomplished by maintaining a rolling estimate of the tracking error that is updated at regular intervals, and using the rolling estimates to further constrain the choice of the weights in the multiple regression analysis. Once the weights are determined so that the hedge portfolio is correlated to the ETF within the desired threshold, the hedge portfolio can be used by the Designated Brokers 110 for arbitrage and hedging purposes. The intraday performance of the hedge portfolio can be continuously compared to the IIV of the ETF throughout the trading day.

Market Intermediary

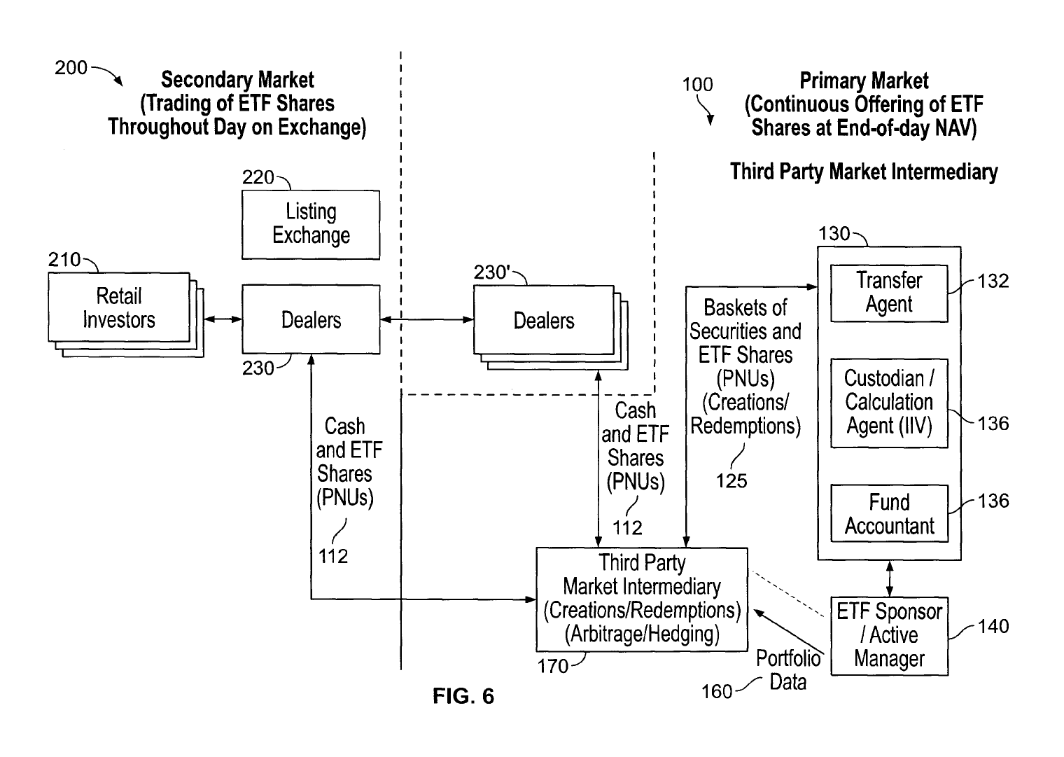

Referring to FIG. 6, in accordance with another aspect of the system 16 herein, a third party market intermediary 170, that may or may not be beneficially owned in whole or in part by the ETF sponsor 140 or an affiliate of the ETF sponsor 140 or by the fund 130 itself, may act as the conduit through which all purchases and redemptions of units take place with the ETF (for example, exchange of cash and ETF shares (PNUs) 112 with dealers 230,230′ and/or exchange of baskets of securities and ETF shares (PNUs) (creations/redemptions) 125 with a third party 130). In this aspect, the market intermediary 170 may transact in the secondary market 200 directly with the dealers 230, or alternately with dealers 230′ that may be a part of the secondary market 200 or interposed between the secondary market 200 and the market intermediary 170. The dealers 230′ may act on their own behalf as principal or serve as an agent for the market intermediary 170. The market intermediary 170 may exchange cash and ETF shares (PNUs) 112 with the dealers 230,230′ and baskets of securities and ETF shares (PNUs) (Creations/Redemptions) 125 with the third party 130. The purchase and sale of ETF shares are preferably at negotiated prices throughout the trading day, and the market intermediary 170 would be authorized to effect creations and redemptions of units of the ETF at the end of day NAV. The market intermediary 170 will be provided with the details of the underlying portfolio data 160 daily, but would be prohibited from releasing this information to any third party. In this aspect, the market intermediary 170 will carry out hedging and arbitrage activities for its own account rather than the blind trust carrying out hedging and arbitrage activities on behalf of Designated Brokers 110 as shown in FIG. 2 previously. The IIV of the underlying portfolio of the ETF would be calculated by for example, the market intermediary 170, the custodian (alternately “custodian” and/or “calculation agent”) 136 or by the ETF sponsor 140 itself, and made available to all market participants 210,230,230′ throughout the trading day.

In addition, FIG. 6 also depicts the secondary market 200 (which may involve the trading of ETF shares throughout the day) which includes one or more retail investors 210, the listing exchange 220 and dealers 230. While the third party 130 comprising the transfer agent 132, the custodian/calculation agent (IIV) 136 and/or the fund accountant 138 is depicted, in some embodiments of the present system 16, the market intermediary 170 may adopt one or more of the activities conducted by the third party 130.

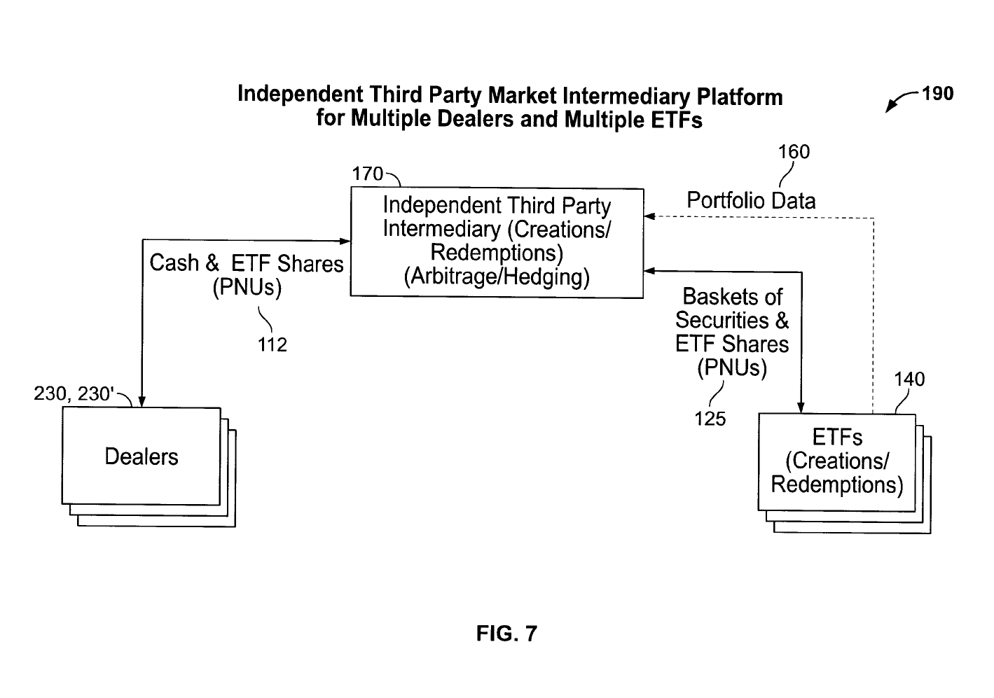

Further, similarly to as noted above, FIG. 7 depicts an embodiment of the system 16—an independent third party market intermediary platform for multiple dealers and multiple ETFs 190—whereby one market intermediary 170 acts in respect of a number of ETF sponsors 140 and, in turn, with a number of dealers 230,230′. As before, cash and ETF shares (PNUs) 112 are exchanged between the dealers 230,230′ and the market intermediary 170, while the market intermediary 170 exchanges baskets of securities and ETF shares (PNUs) 125 with the ETF sponsors 140 in addition to receiving portfolio data 160 from the sponsors 140. This implementation may facilitate efficiencies in the arbitrage and hedging (for example, purchase or short sale) of the portfolio securities underlying the ETFs among the accounts of the market intermediary 170.

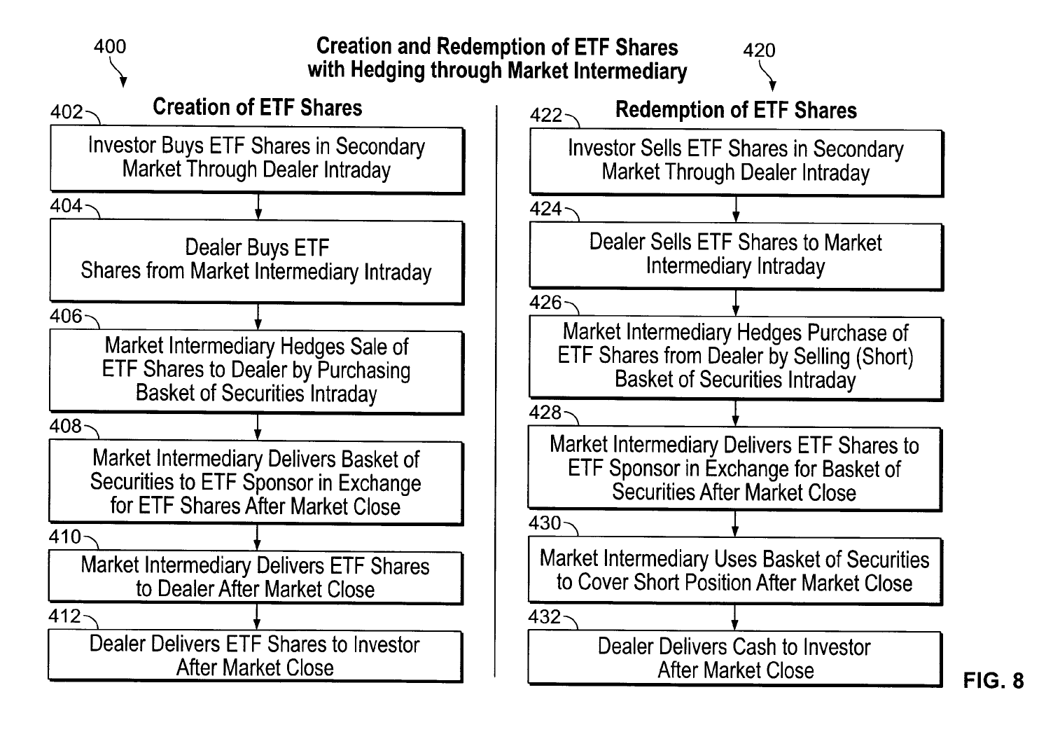

FIG. 8 depicts selected steps of a method of creation of ETF shares with hedging through market intermediary 400 and a method of redemption of ETF shares with hedging through market intermediary 420. The methods 400 and 420 are suitable for use with the system 16 described above and shown in FIGS. 1, 6, 7, 10 and 11, but it is not so limited.

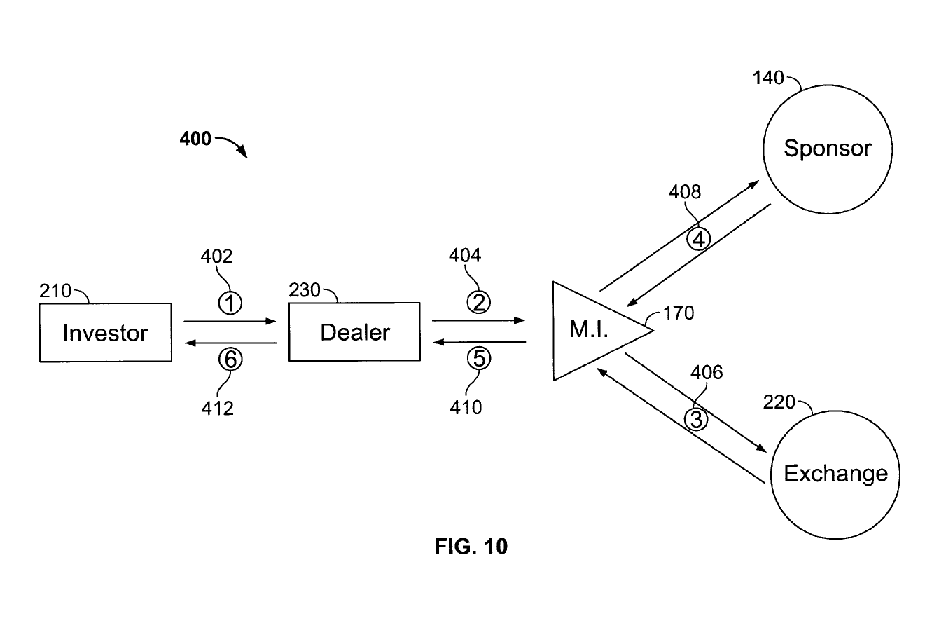

As shown in FIG. 8, and with reference to FIG. 10, the method 400 includes the following steps, among others: the investor buys ETF shares in secondary market through dealer intraday step 402; a dealer buys ETF shares from market intermediary intraday step 404; a market intermediary hedges sale of ETF shares to dealer by purchasing basket of securities intraday step 406; a market intermediary delivers basket of securities to ETF sponsor in exchange for ETF shares after market close step 408; a market intermediary delivers ETF shares to dealer after market close step 410; and the dealer delivers ETF shares to investor after market close step 412. Thus, with reference to FIGS. 8 and 10, it will be appreciated that, according to the method 400, during the day the market intermediary 170 buys the securities from the exchange 220 to hedge against sales of ETF shares (from the sponsor 140) to investors 210 (which may be via the dealer 230), resulting in a creation at the end of the day (or after market close) if the net daily position is a net sale of ETF shares to investors 210.

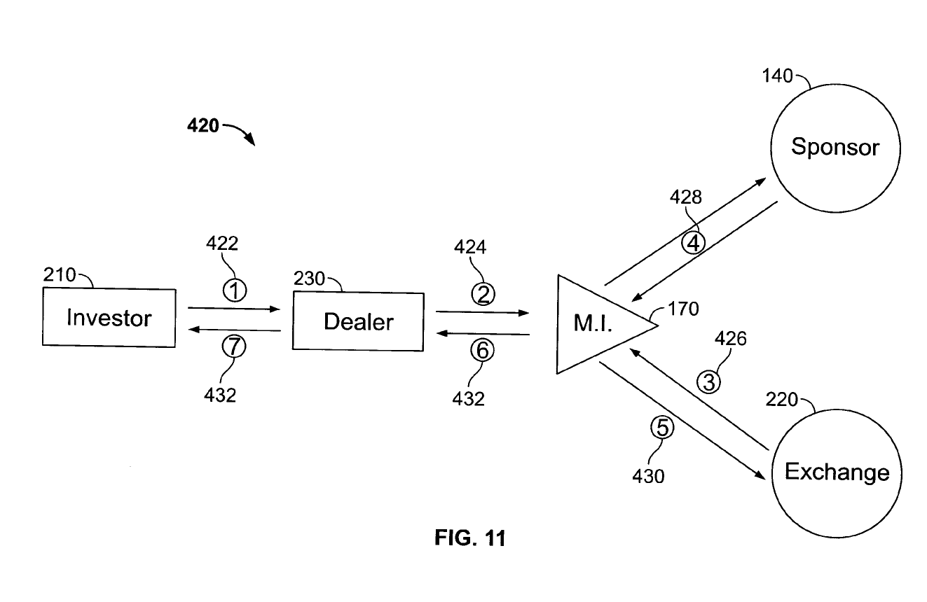

Also as shown in FIG. 8, and with reference to FIG. 11, the method 420 includes the following steps, among others: the investor sells ETF shares in secondary market to dealer intraday step 422; a dealer sells ETF shares to market intermediary intraday step 424; a market intermediary hedges purchase of ETF shares from dealer by selling (short) basket of securities intraday step 426; a market intermediary delivers ETF shares to ETF sponsor in exchange for basket of securities after market close step 428; a market intermediary uses basket of securities to cover short position after market close step 430; and the dealer delivers cash to investor after market close step 432. Thus, with reference to FIGS. 8 and 11, it will be appreciated that, according to the method 420, during the day the market intermediary 170 sells the securities on the exchange 220 to hedge against the purchases of ETF shares from investors 210 (which may be via the dealer 230 and ultimately delivered to the sponsor 140), resulting in a redemption at the end of the day (or after market close) if the net daily position is a net purchase of ETF shares from investors 210.

FIG. 9 depicts selected steps of a method of arbitrage by designated brokers through market intermediary (i) when secondary market price is higher than IIV 440; and (ii) when secondary market price is lower than IIV 460. The methods 440, 460 are suitable for use with the system 16 described above and shown in FIGS. 1, 6, 7, 12 and 13, but it is not so limited.

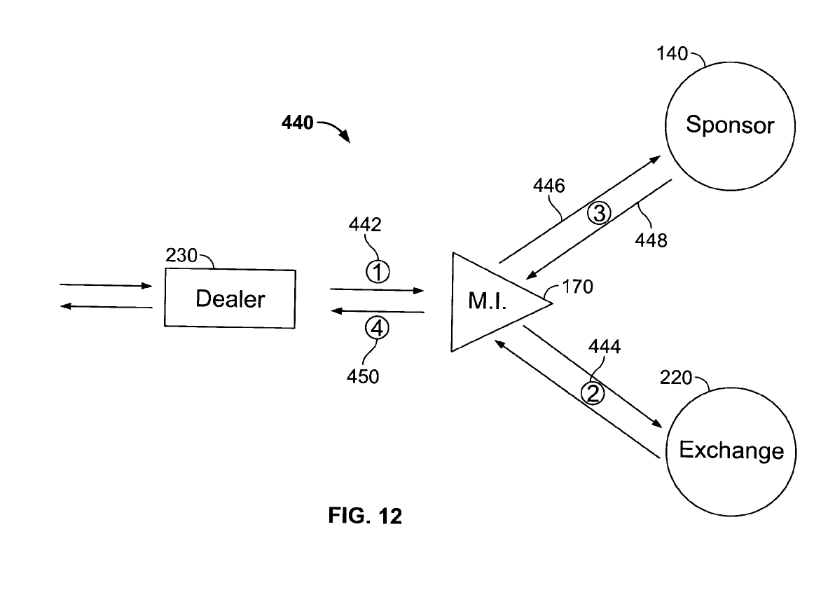

As shown in FIG. 9, and with reference to FIG. 12, the method 440 includes the following steps, among others: (i) a market intermediary sells (short) ETF shares intraday step 442; a market intermediary purchases basket of securities intraday step 444; a market intermediary delivers basket of securities to ETF sponsor in exchange for ETF shares after market close step 446; an ETF sponsor delivers ETF shares to market intermediary step 448; and a market intermediary uses ETF shares to cover short position step 450. Thus, with reference to FIGS. 9 and 12, it will be appreciated that, according to the method 440, during the day the market intermediary 170 sells short the ETF shares (from the sponsor 140) to the designated broker 110 and buys the securities from the exchange 220 to offset short sales, and creates ETF shares at the end of the day (or after market close) if the net daily position is a net short sale of ETF shares.

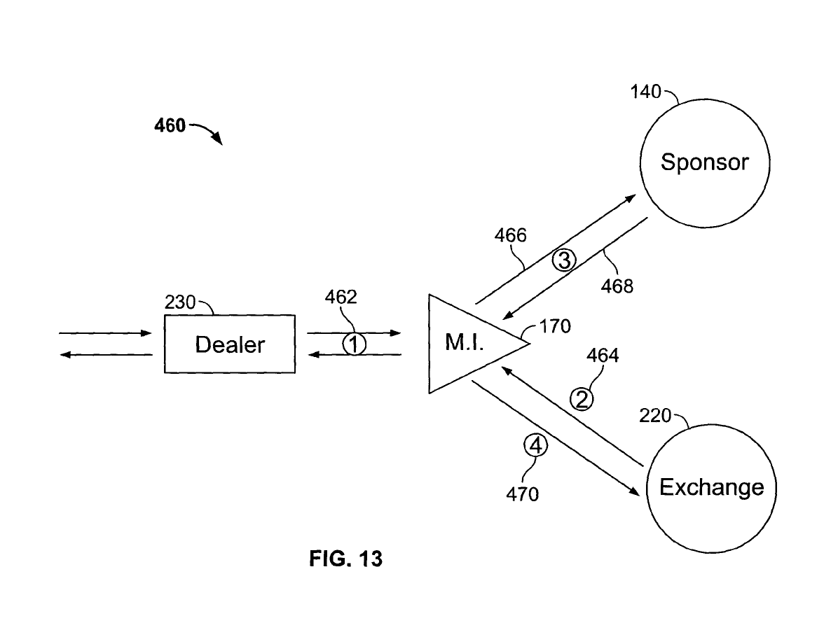

As also shown in FIG. 9, and with reference to FIG. 13, the method 460 includes the following steps, among others: (i) a market intermediary purchases ETF shares intraday step 462; a market intermediary sells (short) basket of securities intraday step 464; a market intermediary delivers ETF shares to ETF sponsor in exchange for basket of securities after market close step 466; an ETF sponsor delivers basket of securities to market intermediary step 468; and a market intermediary uses basket of securities to cover short position step 470. Thus, with reference to FIGS. 9 and 13, it will be appreciated that, according to the method 460, during the day the market intermediary 170 purchases ETF shares (from the designated broker 110 and ultimately delivered to the sponsor 140) and sells short the securities on the exchange 220 to offset the purchases of the ETF shares, resulting in redemption at the end of the day (or after market close) if the net daily position is a net purchase of ETF shares.

It may be understood that with either hedging (as shown in FIGS. 8, 10 and 11) or arbitrage (as shown in FIGS. 9, 12 and 13), the market intermediary 170 is acting as principal (i.e., not as a trustee of a trust for benefit of designated brokers) and becomes in effect the market maker. Accordingly, the market intermediary 170 may provide liquidity to the market, throughout the day, for the ETF by offering to buy and sell the ETF shares. The intermediary 170 may accomplish this by placing orders in the market with dealers 230, 230′.

In another embodiment, the intermediary 170 between the mutual fund 130 and the market makers would be owned in whole or in part by the mutual fund manager, in which case the intermediary 170 would act as principal in transacting with the market makers. While the intermediary 170 would have knowledge of the portfolio of the fund 130, the market makers would not. In this way, the market makers would not have to engage in hedging or arbitrage activities.

A further embodiment may have the intermediary 170 acting as principal and being owned and/or operated by the mutual fund 130 itself (as distinct from the manager).

As an example, with respect to the price of shares compared to the value of the basket of securities, assume that the ETF shares are trading at $9.90/$10.10 with the last trade at $10 at the start of a given thirty minute period. Further assuming that the IIV of the basket of securities is $10 at the start of the period, the value of the basket of securities decreases 10% during the thirty minute period, and the IIV moves down to $9, the arbitrage trade at the end of the thirty minute period would be to short sell the ETF shares and buy the securities (i.e., ETF share arbitrage by market intermediary when secondary market price is greater than IIV 440 as shown in FIG. 9). The arbitrage activity will serve to reduce the ETF share price and increase the IIV until equilibrium is reached (i.e., the spread is too small for an arbitrage profit).

Conversely (continuing the example), assuming the value of the basket of securities increases 10% in the thirty minute period, and the IIV moves up to $11, the arbitrage trade at the end of the thirty minute period would be to purchase the ETF shares and short sell the securities (i.e., ETF share arbitrage by market intermediary when secondary market price is lower than IIV 460, as shown in FIG. 9). The arbitrage activity will serve to increase the ETF share price and reduce the IIV until equilibrium is reached. If the foregoing example arbitrage activities occur over a very short time interval (e.g., seconds), the ETF share price should closely track the IIV.

According to an aspect of the system 16, method and/or computer readable medium herein, a mutual fund 130 may issue one or more classes of conventional shares or units that are bought from and redeemed with the mutual fund 130 at net asset value (or NAV), and one or more classes of shares or units that are listed for trading on a stock exchange as an ETF. The system 16, method and/or computer readable medium herein is intended to allow a mutual fund 130 to offer multiple share classes, including at least one class of conventional shares and at least one class of exchange traded shares. Thus, in contrast to the conventional approach of offering exchange traded shares by creating a new investment fund that offers only exchange traded shares, the present system 16, method and/or computer readable medium is intended to permit a sponsor 140 to offer ETF shares as a separate class of a multi-class mutual fund.

A shareholder may acquire ETF shares of the mutual fund 130 in one of three ways: (1) by purchasing the ETF shares in the secondary market through a broker (or dealer 230), at the prevailing market price, (2) by converting a designated number of conventional mutual fund shares or units into a monetarily equivalent number of ETF class shares issued by the same mutual fund 130, and/or (3) if the purchaser is a Designated Broker 110, by acquiring PNUs of ETF class shares directly from the mutual fund 130 in exchange for a basket of securities as discussed above.

ETF class shares may be sold or redeemed in one of two different ways: (1) Designated Brokers 110 may redeem ETF class shares directly with the mutual fund 130 in exchange for a basket of securities of generally equivalent monetary value in the form of PNUs, and/or (2) shareholders may sell ETF class shares directly on the secondary market 200 through a broker (or dealer 230).

According to an aspect herein (and as may be shown in FIG. 6), there is provided a method of facilitating the creation and redemption of units of an actively-managed ETF comprising providing a third party market intermediary, that may or may not be an affiliate of the ETF sponsor, allowing the third party market intermediary 170 to carry out hedging and arbitrage activities for its own account based on a periodically published, at a predetermined interval, value (called the intraday indicative value (“IIV”)) of the underlying holdings of the ETF. The composition of the portfolio of securities of the ETF will be made known by the ETF sponsor 140 to the market intermediary 170, but not to any other third party. The market intermediary 170 may transact in the secondary market 200 for the purchase and sale of ETF shares at negotiated prices intraday with, for example, a dealer 230′. The dealer 230′ may be part of the secondary market 200 or interposed between the secondary market 200 and the market intermediary 170.

As noted above (and shown in FIG. 7), this system 16, method and/or computer readable medium may be implemented whereby one third party acts as market intermediary 170 in respect of a number of actively-managed ETFs 140.

The aspects and embodiments of the system 16, method and/or computer readable medium herein are further intended to facilitate a mutual fund 130 in having both conventional classes of mutual fund shares/units while also issuing one or more classes of shares or units that are listed for trading on a securities exchange 220 and are bought and sold at negotiated market prices.

Persons skilled in the art should appreciate, in view of the disclosures herein, how a brokerage account may instead stand in place of the blind trust 120 and/or market intermediary 170. Persons skilled in the art should also appreciate, in view of the disclosures herein, how such brokerage account may conduct hedging and/or arbitrage activities based on updates periodically received from the sponsor 140 concerning the securities in the fund 130, and/or based on a multi-factor analysis involving publicly available information concerning performance of the fund 130 (each as may be described in detail elsewhere herein).

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

It should be appreciated that, although some of the components, relations, configurations and/or steps of the systems, methods and computer readable media according to the invention are not specifically referenced in association with one another, they may be used, and/or adapted for use, in association therewith.

All of the aforementioned, depicted and various structures, configurations, relationships, utilities and the like may be, but are not necessarily, incorporated into and/or achieved by the invention. Any one or more of the aforementioned structures, configurations, relationships, utilities and the like may be implemented in and/or by the invention, on their own, and/or without reference, regard or likewise implementation of any of the other aforementioned structures, configurations, relationships, utilities and the like, in various permutations and combinations, as will be readily apparent to those skilled in the art, without departing from the pith, marrow, and spirit of the disclosed invention.

This concludes the description of presently preferred embodiments of the invention. The foregoing description has been presented for the purpose of illustration and is not intended to be exhaustive of to limit the invention to the precise form disclosed. Other modifications, variations and alterations are possible in light of the above teaching and will be apparent to those skilled in the art, and may be used in the design and manufacture of other embodiments according to the present invention without departing from the spirit and scope of the invention. It is intended the scope of the invention be limited not by this description but only by the claims forming a part hereof.

1-54. (canceled)

55. A system for buying and selling, on a secondary market, shares of a fund actively managed by a sponsor and comprised of securities traded on one or more exchanges, with a complete list of the securities currently included in the fund being kept confidential from the secondary market, the system comprising:
a) a secondary market subsystem adapted to receive from the secondary market:
i) a buy order for the shares to be provided to the secondary market in trade for a first negotiated price to be collected from the secondary market; and
ii) a sell order for a second negotiated price to be provided to the secondary market in trade for the shares to be collected from the secondary market;
b) a fund subsystem adapted to: receive updates from the sponsor on the securities then included in the fund; and trade in-kind, with the sponsor, the shares and a basket of the securities that was underlying the shares;
c) a blind trust/intermediary exchange subsystem adapted to buy and sell the basket of the securities on the exchanges during the trading day; and
d) one or more processors operatively encoded to:
i) after the secondary market subsystem receives the buy order, perform a buy workflow wherein the processors instruct (A) the secondary market subsystem to collect the first negotiated price from the secondary market, (B) the exchange subsystem to, as a first hedging activity, forthwith buy within a blind trust and/or a market intermediary the basket of the securities on the exchanges during the trading day, (C) the fund subsystem to trade the basket in-kind for the shares from the sponsor, and (D) the secondary market subsystem to provide the shares to fulfill the buy order on the secondary market; and
ii) after the secondary market subsystem receives the sell order, perform a sell workflow wherein the processors instruct (A) the secondary market subsystem to collect the shares from the secondary market, (B) the exchange subsystem to, as a second hedging activity, forthwith short sell within the blind trust and/or the market intermediary the basket of the securities on the exchanges during the trading day, (C) the fund subsystem to trade the shares in-kind for the basket from the sponsor, (D) the exchange subsystem to provide the basket of the securities to fulfill the aforesaid short sale of the basket on the exchanges, and (E) the secondary market subsystem to provide the second negotiated price to fulfill the sell order on the secondary market.

56. A system according to claim 55, wherein the fund subsystem is adapted to receive the updates from the sponsor before opening of the exchanges each trading day, and trade in-kind with the sponsor after closing of the exchanges on said trading day; wherein the basket of the securities was underlying the shares before said opening; wherein the processors instruct the fund subsystem: in the buy workflow, to trade the basket in-kind for the shares from the sponsor after said closing; and in the sell workflow, to trade the shares in-kind for the basket from the sponsor after said closing.

57. A system according to claim 55, wherein the processors are operatively encoded to, when triggered by a user, perform the buy workflow and the sell workflow.

58. A system according to claim 55, wherein the processors are operatively encoded to, automatically, perform the buy workflow and the sell workflow.

59. A system according to claim 55, wherein the secondary market subsystem, the fund subsystem, and the processors are adapted for use by the market intermediary.

60. A system according to claim 55, wherein the secondary market subsystem, the fund subsystem, and the processors are adapted for use by a trustee of the blind trust.

61. A system according claim 55, wherein the shares are bought and sold on the secondary market via one or more dealers, designated brokers and authorized participants; and wherein the secondary market subsystem receives the buy order and the sell order from the secondary market via said dealers, designated brokers and authorized participants.

62. A system according claim 55, wherein the processors are also operatively encoded to, when the first negotiated price is greater than an accurate real-time intraday value of the basket as calculated based on the securities in the basket as then trading on the exchanges, perform an arbitrage workflow wherein the processors instruct (a) the secondary market subsystem to short sell the shares on the secondary market, (b) the exchange subsystem to buy the basket of the securities on the exchanges, (c) the fund subsystem to trade the basket for the shares, and (d) the secondary market subsystem to provide the shares to fulfill the aforesaid short sale of the shares on the secondary market.

63. A system according to claim 62, wherein the processors only perform the arbitrage workflow when the first negotiated price is greater than the accurate real-time intraday value by a predetermined amount or percentage.

64. A system according to claim 55, wherein the processors are also operatively encoded to, when the second negotiated price is less than an accurate real-time intraday value of the basket as calculated based on the securities in the basket as then trading on the exchanges, perform an arbitrage workflow wherein the processors instruct (a) the secondary market subsystem to buy the shares in the secondary market, (b) the exchange subsystem to short sell the basket of the securities on the exchanges, (c) the fund subsystem to trade the shares for the basket, and (d) the exchange subsystem to provide the basket to fulfill the aforesaid short sale of the basket of the securities on the exchanges.

65. A system according to claim 64, wherein the processors only perform the arbitrage workflow when the second negotiated price is less than the accurate real-time intraday value by a predetermined amount or percentage.

66. A system according to claim 62, wherein the processors are operatively encoded to, when triggered by a user, perform the arbitrage workflow.

67. A system according to claim 62, wherein the processors are operatively encoded to, automatically, perform the arbitrage workflow.

68. A system according to claim 62, wherein the accurate real-time intraday value is disclosed to the secondary market at one or more times during the trading day.

69. A system according to claim 55, wherein the fund subsystem is further adapted to, only in prescribed numbers of units, trade the shares and the basket as aforesaid.

70. A system according to claim 55 adapted for use with a mutual fund as the fund, wherein the mutual fund includes multiple share classes including at least a first class of conventional mutual fund shares and at least a second class of exchange traded fund shares; and with the system adapted for use with the second class of exchange traded fund shares as the shares to be bought and sold on the secondary market as aforesaid.

71. A method of buying and selling, on a secondary market, shares of a fund actively managed by a sponsor and comprised of securities traded on one or more exchanges, with a complete list of the securities currently included in the fund being kept confidential from the secondary market, the method comprising the steps of:
a) receiving from the secondary market:
i) a buy order for the shares to be provided to the secondary market in trade for a first negotiated price to be collected from the secondary market; and
ii) a sell order for a second negotiated price to be provided to the secondary market in trade for the shares to be collected from the secondary market;
b) receiving updates from the sponsor on the securities then included in the fund;
c) a buy workflow step, after receiving the buy order, of (i) collecting the first negotiated price from the secondary market, (ii) as a first hedging activity, forthwith buying within a blind trust and/or a market intermediary, on the exchanges during the trading day, a basket of the securities underlying the shares,
(iii) trading the basket in-kind for the shares from the sponsor, and (iv) providing the shares to fulfill the buy order on the secondary market; and
d) a sell workflow step, after receiving the sell order, of (i) collecting the shares from the secondary market, (ii) as a second hedging activity, forthwith short selling within the blind trust and/or the market intermediary the basket of the securities on the exchanges during the trading day, (iii) trading the shares in-kind for the basket from the sponsor, (iv) providing the basket of the securities to fulfill the aforesaid short sale of the basket on the exchanges, and (v) providing the second negotiated price to fulfill the sell order on the secondary market.

72. A method according to claim 71 wherein, in step (b), the updates are received from the sponsor before opening of the exchanges each trading day; wherein the basket of the securities was underlying the shares before said opening; wherein in the buy workflow step (c), the basket is traded in-kind for the shares from the sponsor after closing of the exchanges on said trading day; and wherein in the sell workflow step (d), the shares are traded in-kind for the basket from the sponsor after said closing.

73. A method according to claim 71, wherein the buy workflow step and the sell workflow step are performed when triggered by a user.

74. A method according to claim 71, wherein the buy workflow step and the sell workflow step are automatically performed.

75. A method according to claim 71 adapted for use by the market intermediary.

76. A method according to claim 71 adapted for use by a trustee of the blind trust.

77. A method according to claim 71 wherein, in steps (c) and (d), the shares are bought and sold on the secondary market via one or more dealers, designated brokers and authorized participants; and wherein, in step (a), the buy order and the sell order are received from the secondary market via said dealers, designated brokers and authorized participants.

78. A method according to claim 71, further comprising an arbitrage workflow step, when the first negotiated price is greater than an accurate real-time intraday value of the basket as calculated based on the securities in the basket as then trading on the exchanges, of (e) short selling the shares on the secondary market, (f) forthwith buying the basket of the securities on the exchanges during the trading day, (g) trading the basket in-kind for the shares from the sponsor, and (h) providing the shares to fulfill the aforesaid short sale of the shares on the secondary market.

79. A method according to claim 78, wherein the arbitrage workflow step is only performed when the first negotiated price is greater than the accurate real-time intraday value by a predetermined amount or percentage.

80. A method according to claim 71, further comprising an arbitrage workflow step, when the second negotiated price is less than an accurate real-time intraday value of the basket as calculated based on the securities in the basket as then trading on the exchanges, of (e) buying the shares in the secondary market, (f) forthwith short selling the basket of the securities on the exchanges during the trading day, (g) trading the shares in-kind for the basket from the sponsor, and (h) providing the basket to fulfill the aforesaid short sale of the basket of the securities on the exchanges.

81. A method according to claim 80, wherein the arbitrage workflow step is only performed when the second negotiated price is less than the accurate real-time intraday value by a predetermined amount or percentage.

82. A method according to claim 78, wherein the arbitrage workflow step is performed when triggered by a user.

83. A method according to claim 78, wherein the arbitrage workflow step is automatically performed.

84. A method according to claim 78, further comprising the step of disclosing the accurate real-time intraday value to the secondary market at one or more times during the trading day.

85. A method according to claim 71 wherein, in steps (c) and (d), only prescribed numbers of units of the basket and the shares are traded in-kind with the sponsor as aforesaid.

86. A method according to claim 71 adapted for use with a mutual fund as the fund, wherein the mutual fund includes multiple share classes including at least a first class of conventional mutual fund shares and at least a second class of exchange traded fund shares; and with the method adapted for use with the second class of exchange traded fund shares as the shares bought and sold on the secondary market as aforesaid.

87. A computer readable medium for use in buying and selling, on a secondary market, shares of a fund actively managed by a sponsor and comprised of securities traded on one or more exchanges, with a complete list of the securities currently included in the fund being kept confidential from the secondary market, the computer readable medium encoded with executable instructions to, when executed, encode one or more processors to automatically perform the steps of:
a) receiving updates from the sponsor on the securities then included in the fund;
b) after receiving, from the secondary market, a buy order for the shares to be provided to the secondary market in trade for a first negotiated price to be collected from the secondary market, a buy workflow step of instructing
(i) collection of the first negotiated price from the secondary market, (ii) forthwith buying within a blind trust and/or a market intermediary, as a first hedging activity on the exchanges during the trading day, of a basket of the securities underlying the shares, (iii) trading of the basket in-kind for the shares from the sponsor, and (iv) providing of the shares to fulfill the buy order on the secondary market; and
c) after receiving, from the secondary market, a sell order for a second negotiated price to be provided to the secondary market in trade for the shares to be collected from the secondary market, a sell workflow step of instructing (i) collection of the shares from the secondary market, (ii) forthwith short selling within the blind trust and/or the market intermediary of the basket of the securities as a second hedging activity on the exchanges during the trading day, (iii) trading of the shares in-kind for the basket from the sponsor, (iv) providing of the basket of the securities to fulfill the aforesaid short sale of the basket on the exchanges, and (v) providing of the second negotiated price to fulfill the sell order on the secondary market.

88. A computer readable medium according to claim 87 wherein the executable instructions, when executed, further encode the processors such that: in step (a), the updates are received from the sponsor before opening of the exchanges each trading day; the basket of the securities was underlying the shares before said opening; in the buy workflow step (c), the basket is traded in-kind for the shares from the sponsor after closing of the exchanges on said trading day; and in the sell workflow step (d), the shares are traded in-kind for the basket from the sponsor after said closing.

89. A computer readable medium according to claim 87, wherein the executable instructions, when executed, further encode the processors to perform the buy workflow step and the sell workflow step when triggered by a user.

90. A computer readable medium according to claim 87, wherein the executable instructions, when executed, further encode the processors to automatically perform the buy workflow step and the sell workflow step.

91. A computer readable medium according to claim 87 adapted for use by the market intermediary.

92. A computer readable medium according to claim 87 adapted for use by a trustee of the blind trust.

93. A computer readable medium according to claim 87 wherein the executable instructions, when executed, further encode the processors to, in steps (b) and (c), instruct buying and selling of the shares on the secondary market via one or more dealers, designated brokers and authorized participants; and wherein, before steps (b) and (c), the buy order and the sell order are received from the secondary market via said dealers, designated brokers and authorized participants.

94. A computer readable medium according to claim 87, wherein the executable instructions, when executed, further encode the processors to perform an arbitrage workflow step, when the first negotiated price is greater than an accurate real-time intraday value of the basket as calculated based on the securities in the basket as then trading on the exchanges, of instructing (d) short selling of the shares on the secondary market, (e) forthwith buying of the basket of the securities on the exchanges during the trading day, (f) trading of the basket in-kind for the shares from the sponsor, and (g) providing of the shares to fulfill the aforesaid short sale of the shares on the secondary market.

95. A computer readable medium according to claim 94, wherein the executable instructions, when executed, further encode the processors to only perform the arbitrage workflow step when the first negotiated price is greater than the accurate real-time intraday value by a predetermined amount or percentage.

96. A computer readable medium according to claim 87, wherein the executable instructions, when executed, further encode the processors to perform an arbitrage workflow step, when the second negotiated price is less than an accurate real-time intraday value of the basket as calculated based on the securities in the basket as then trading on the exchanges, of instructing (d) buying of the shares in the secondary market,
(e) forthwith short selling of the basket of the securities on the exchanges during the trading day, (f) trading of the shares in-kind for the basket from the sponsor, and (g) providing of the basket to fulfill the aforesaid short sale of the basket of the securities on the exchanges.

97. A computer readable medium according to claim 96, wherein the executable instructions, when executed, further encode the processors to only perform the arbitrage workflow step when the second negotiated price is less than the accurate real-time intraday value by a predetermined amount or percentage.

98. A computer readable medium according to claim 94, wherein the executable instructions, when executed, further encode the processors to perform the arbitrage workflow step when triggered by a user.

99. A computer readable medium according to claim 94, wherein the executable instructions, when executed, further encode the processors to automatically perform the arbitrage workflow step.

100. A computer readable medium according to claim 94, wherein the executable instructions, when executed, further encode the processors to instruct disclosure of the accurate real-time intraday value to the secondary market at one or more times during the trading day.

101. A computer readable medium according to claim 87 wherein the executable instructions, when executed, further encode the processors to, in steps (b) and (c), instruct only prescribed numbers of units of the basket and the shares to be traded in-kind with the sponsor as aforesaid.

102. A computer readable medium according to claim 87 adapted for use with a mutual fund as the fund, wherein the mutual fund includes multiple share classes including at least a first class of conventional mutual fund shares and at least a second class of exchange traded fund shares; and with the computer readable medium adapted for use with the second class of exchange traded fund shares as the shares which are to be bought and sold on the secondary market as aforesaid.
